(19) United States
(12) Patent Application Publication
(10) Pub. No.: US 2025/0256858 A1
(43) Pub. Date: Aug. 14, 2025

(54) Methods and Apparatus for Mounting a Gas Turbine Engine to a Pylon

(71) Applicant: General Electric Company, Schenectady, NY (US)

(72) Inventors: Neil Christian WIHELMUS, Highland Heights, KY (US); Anthony J. MAURER, Liberty Township, OH (US); Jonathan E. COLEMAN, Mason, OH (US); Daniel DIAZ, Mason, OH (US); Timothy Leo SHELFAUT, Lebanon, OH (US); Craig W. HIGGINS, Evendale, OH (US); Daniel E. MOLLMANN, Evendale, OH (US); Thomas Peter JOSEPH, West Chester, OH (US); Amit ZUTSHI, Evendale, OH (US)

(21) Appl. No.: 18/617,268

(22) Filed: Mar. 26, 2024

Related U.S. Application Data
(60) Provisional application No. 63/589,170, filed on Oct. 10, 2023.
(60) Provisional application No. 63/518,992, filed on Aug. 11, 2023.

(51) Int. Cl. B64D 27/40

(52) U.S. Cl. CPC B64D 27/402; B64D 27/406

(57) ABSTRACT

Systems, apparatus, articles of manufacture, and methods for mounting a gas turbine engine to a pylon are disclosed. An example gas turbine engine disclosed herein a first mount, a first frame portion to be coupled to a pylon via the first mount, a second frame portion coupled to the first frame portion such that second frame portion is cantilevered from the first frame portion, and a second mount to couple the second frame portion to the pylon, the second mount defining a load path between the pylon and the second frame portion, the second mount including an elastic element disposed in the load path.

### RELATED APPLICATIONS

This application claims priority to U.S. Provisional Patent Application No. 63/589,170, filed on Oct. 10, 2023, and entitled “METHODS AND APPARATUS FOR MOUNTING A GAS TURBINE ENGINE TO A PYLON,” and U.S. Provisional Patent Application No. 63/518,992, filed on Aug. 11, 2023, and entitled “METHODS AND APPARATUS FOR MOUNTING A GAS TURBINE ENGINE TO A PYLON,” both of which are incorporated herein by reference in their entireties.

### FIELD OF THE DISCLOSURE

This disclosure relates generally to gas turbines, and, more particularly, to methods and apparatus for mounting a gas turbine engine to a pylon.

### BACKGROUND

A gas turbine engine generally includes, in serial flow order, an inlet section, a compressor section, a combustion section, a turbine section, and an exhaust section. In operation, air enters the inlet section and flows to the compressor section where one or more axial compressors progressively compress the air until it reaches the combustion section, thereby creating combustion gases. The combustion gases flow from the combustion section through a hot gas path defined within the turbine section and then exit the turbine section via the exhaust section.

### BRIEF DESCRIPTION OF THE DRAWINGS

A full and enabling disclosure of the present disclosure, including the best mode thereof, directed to one of ordinary skill in the art, is set forth in the specification, which makes reference to the appended FIGS., in which:

FIG. 1 is a cross-sectional view of an example gas turbine engine in which examples disclosed herein may be implemented.

FIG. 2 is a perspective view of an example frame components of a gas turbine engine coupled to a pylon including an aft mount implemented in accordance with the teachings of this disclosure.

FIG. 3 is a perspective view of the aft mount of FIG. 2.

FIG. 4 is a perspective view of another aft mount implemented in accordance with the teachings of this disclosure.

FIG. 5A is a perspective view of another aft mount implemented in accordance with the teachings of this disclosure.

FIG. 5B is a cross-sectional view of another aft mount implemented in accordance with the teachings of this disclosure.

FIG. 6 is a perspective view of a thrust linkage configuration that can be used in conjunction with the frame components and the aft mount of FIG. 2.

FIG. 7 is a perspective view of a rear coupling of a thrust linkage configuration of FIG. 6.

FIG. 8 is a perspective view of another thrust linkage configuration that can be used in conjunction with the frame components and the aft mount of FIG. 2.

FIG. 9 is a perspective view of another thrust linkage configuration that can be used in conjunction with the frame components and the aft mount of FIG. 2.

FIG. 10 is a perspective view of a gas turbine engine including the aft mount of FIG. 5A and the thrust linkage configuration of FIG. 6.

FIG. 11 is a perspective view of a gas turbine engine including another aft mount and the thrust linkage configuration of FIG. 6.

FIG. 12A is a front view of the aft mount of FIG. 11 including an example first frame coupling.

FIG. 12B is a front view of the aft mount of FIG. 11 including an example second frame coupling.

FIG. 12C is a front view of the aft mount of FIG. 11 including an example third frame coupling.

FIG. 12D is a front view of the aft mount of FIG. 11 including an example fourth frame coupling.

FIG. 12E is a front view of the aft mount of FIG. 11 including an example fifth frame coupling.

FIG. 12F is a front view of the aft mount of FIG. 11 including an example sixth frame coupling.

FIG. 12G is a front view of the aft mount of FIG. 11 including an example seventh coupling.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, joined, etc.) are to be construed broadly and may include intermediate members between a collection of elements and relative movement between elements unless otherwise indicated. As such, connection/disconnection references do not necessarily infer that two elements are directly connected and in fixed relation to each other. Stating that any part is in “contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Compressor blade tip clearances in gas turbine engines are affected by operational distortions caused by the internal forces of the gas turbine engines. Particularly, thrust, aerodynamic, and/or propeller loads can create internal bending moments in the gas turbine engine, which can cause the gas turbine engine to bend between the mounting linkages of the gas turbine engines. In recent years, some gas turbine engines have mitigated the distortions caused by such internal forces via cantilevered coupled core sections. However, the reaction of the gravitational loads of the cantilevered cores via the forward mounts of the gas turbine engine can cause distortions within the core section. Examples disclosed herein provide a mount system including an aft mount that includes an elastic element. Example mounts disclosed herein react a portion of the vertical load of a cantilevered core while reducing the operational distortions caused by bending moments associated with the thrust, aerodynamic, and/or propeller loads. Example mounts disclosed herein reduce distortions caused by the gravitational loading via an elastic member.

Some engines including cantilevered cores can experience comparatively large vertical (e.g., yaw axis aligned, etc.) and lateral (e.g., pitch axis aligned, etc.) displacements during operation. Particularly, because the cantilevered cores are not directly coupled to the pylon, such cores can vertically and laterally displace during operation. In some examples, such displacements can reduce the efficacy of seals within the gas turbine engine and can make integration of the cantilevered core with the nacelle difficult. Examples disclosed herein include thrust link configurations that mitigate such vertical and lateral displacements associated with cantilevered cores. Examples disclosed herein include a mount system for a cantilevered core engine to react some or all of the bending moments between thrust linkages of the engine. In some example mount systems disclosed herein, thrust linkages are provided that have laterally displaced coupling points, which enables the thrust linkages to react yaw moments and reduce lateral displacements. In some example mount systems disclosed herein, thrust linkages are provided that have vertically displaced coupling points, which enables the thrust linkages to react pitch moments and reduce vertical displacements.

The terms “upstream” and “downstream” refer to the relative direction with respect to fluid flow in a fluid pathway. For example, “upstream” refers to the direction from which the fluid flows, and “downstream” refers to the direction to which the fluid flows. As used herein, the term “linkage” refers to a connection between two parts that restrain the relative motion of the two parts (e.g., restrain at least one degree of freedom of the parts, etc.).

Various terms are used herein to describe the orientation of features. As used herein, the orientation of features, forces, and moments are described with reference to the yaw axis, pitch axis, and roll axis of the vehicle associated with the features, forces, and moments. In general, the attached figures are annotated with reference to the axial direction, radial direction, and circumferential direction of the gas turbine associated with the features, forces, and moments. In general, the attached figures are annotated with a set of axes including the roll axis R, the pitch axis P, and the yaw axis Y. As used herein, the terms “longitudinal,” and “axial” are used interchangeably to refer to directions parallel to the roll axis. As used herein, the term “lateral” is used to refer to directions parallel to the pitch axis. As used herein, the term “vertical” is used to refer to directions parallel to the yaw axis.

“Including” and “comprising” (and all forms and tenses thereof) are used herein to be open-ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Some prior gas turbine engines are configured to be mounted to the wings of an aircraft (e.g., under-wing mounting) via a pylon. These pylons transfer the loads associated with the operation of gas turbine engines (e.g., thrust loads, aero-inlet loads, propeller loads, gravitational loading/weight, etc.) to the wing of the aircraft. Some such prior gas turbine engine is mounted to the pylon via a forward mount and an aft mount for the engine. In some prior-art examples, the forward mount couples the fan casing of the gas turbine engine to the pylon and the aft mount couples the core section of the gas turbine engine to the gas turbine engine. Other prior gas turbine engines do not include mounts to couple the core section to the pylon and include two forward mounts to couple the forward frame portions of such gas turbine engines to the pylon. The core sections of such gas turbine engines are referred to as “cantilevered core sections” because such core sections are cantilevered relative to the forward sections of the gas turbine engine.

Open rotor gas turbine engines, also called open fan gas turbine engines, propfans, and/or unducted fan gas turbine engines, are gas turbine engines that include fans with unducted blades. Open rotor gas turbines offer high performance and fuel efficiency and lack the fan casing of traditional turbofan gas turbine engines. In some such engine configurations, gas turbine engine components that are typically disposed within the fan casing (e.g., the accessory gearbox, oil tanks, etc.) are disposed at another location for gas turbine engines, such as the core casing. However, the disposing of such components within the core casing can increase gravitational loading on the core engine.

In some gas turbine engines, particularly open rotor engines and turboprop engines, a high vibratory load is experienced during various phases of the flight due to asymmetric propeller loading (e.g., P-Factor or 1P loading). 1P loading, also referred to as +/−1P loading, is the asymmetric force on blades and asymmetric disk loading caused by aerodynamic forces at aircraft angles of attack. 1P loading is typically highest during operational conditions with high-power and high angles of attack, such as takeoff and climb.

Blade tip clearances at several locations throughout the engine are often defined based on the sum of axisymmetric closures and the local circumferential clearance distortions during a take-off (TO) rotation maneuver. That is, in some examples, a minimum blade tip clearances in the compressor (e.g., closest clearances, etc.) can occur during TO engine operation. In some examples, the minimum blade tip clearance at which the compressor can operate during take-off is based on clearance reduction caused in part by engine vibrations and distortion (e.g., strain, etc.) caused by the operation of the engine. Operational distortion in an engine can be caused by internal forces and/or moments in the engine caused by thrust, 1P loading, aero inlet loads, etc. The operational loads can cause the engine body to bend and/or otherwise distort between the forward and aft mount attachment point of the gas turbine engine to the aircraft, for example. Designing an engine to compensate for these distortions (e.g., by increasing cold or cruise clearances) correspondingly reduces engine operating efficiency (e.g., specific fuel consumption, etc.). In some prior-art engine configurations, the generated bending moments (e.g., moments about the yaw and pitch axis, etc.) are reacted through the engine carcass (e.g., the fan and core sections of the engine, etc.). The reaction of the bending moments through the engine carcass can cause deterioration (e.g., deformation, distortion) of the engine, which in turn affects blade tip clearances. Other prior-art engine configurations, such as cantilevered core gas turbine engines, do not generate carcass bending due to the lack of an aft mount.

Examples disclosed herein provide a mount system suitable for use with a cantilevered open rotor gas turbine engine. Example mount systems described herein include a gas turbine engine frame with a partially cantilevered core section coupled to a pylon. Examples disclosed herein include a tuned stiffness aft mount that couples a rear frame of a core section to a pylon. Some example aft mounts disclosed herein include an elastomer to partially react vertical loads and reduce distortions transmitted through the engine carcass. Some example aft mounts disclosed herein include a spring to partially react vertical loads and reduce distortions transmitted through the engine carcass. Some example aft mounts disclosed herein include a composite disc spring to partially react vertical loads. In some examples disclosed herein, the aft mounts include features that react yaw-moments during out-of-standard operation. In some such examples disclosed herein, the aft mount includes a slot. In some examples disclosed herein, the aft mount includes a first member having a hollow interior and a second member disposed within the hollow interior. Example mount systems disclosed herein reduce operational distortions associated with the reaction of bending mounts between engine forward mounts and aft mounts and reduce gravitational distortion associated with cantilevered engine configurations.

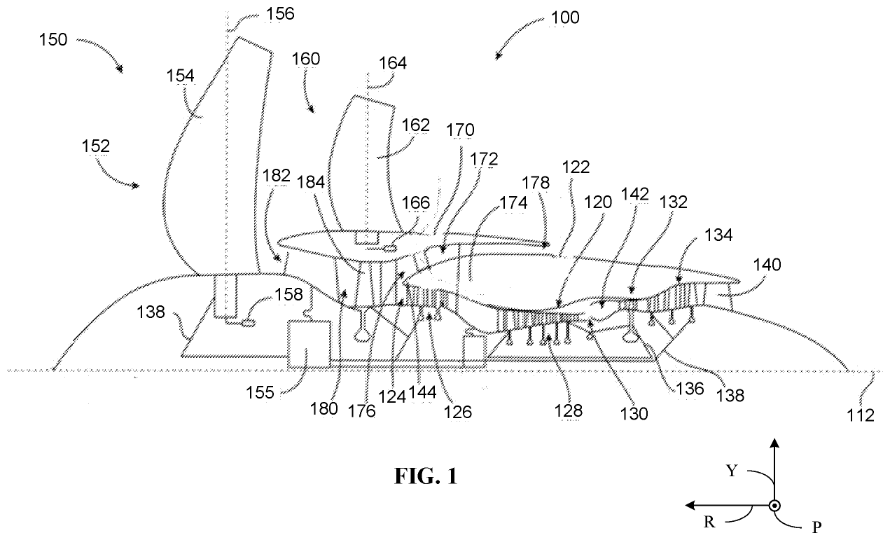

FIG. 1 is a schematic cross-sectional view of an example gas turbine engine 100 that can be used to implement the teachings of this disclosure. The gas turbine engine 100 can be mounted to an aerial vehicle, such as a fixed-wing aircraft, and can produce thrust for propulsion of the aerial vehicle. The gas turbine engine 100 includes a fan that is not ducted by a nacelle or cowl, such that it may be referred to herein as an “unducted fan,” or the entirety of the gas turbine engine 100 may be referred to as an “unducted engine,” “an open-rotor gas turbine engine,” “an open-fan gas turbine engine,” etc.

The gas turbine engine 100 includes a core engine 120 and a fan section 150 positioned upstream thereof. Generally, the core engine 120 includes, in serial flow order, a compressor section, a combustion section, a turbine section, and an exhaust section. Particularly, as shown in FIG. 1, the core engine 120 includes a core cowl 122 that defines an annular core inlet 124. The core cowl 122 further encloses a low-pressure system and a high pressure system. In certain examples, the core cowl 122 may enclose and support a booster or low pressure (“LP”) compressor 126 for pressurizing the air that enters the core engine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 where fuel is injected into the pressurized air stream and ignited to raise the temperature and energy level of the pressurized air. It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems and are not meant to imply any absolute speed and/or pressure values.

The high energy combustion products flow from the combustor 130 downstream to a high pressure turbine 132. The high pressure turbine 132 drives the HP compressor 128 through a high pressure shaft 136. In this regard, the high pressure turbine 132 is drivingly coupled with the HP compressor 128. The high energy combustion products then flow to a low pressure turbine 134. The low pressure turbine 134 drives the LP compressor 126 and components of the fan section 150 through a low pressure shaft 138. In this regard, the low pressure turbine 134 is drivingly coupled with the LP compressor 126 and components of the fan section 150. The LP shaft 138 is coaxial with the HP shaft 136 in this example. After driving each of the turbines 132, 134, the combustion products exit the core engine 120 through a core exhaust nozzle 140 to produce propulsive thrust. Accordingly, the core engine 120 defines a core flow path or core duct 142 that extends between the core inlet 124 and the core exhaust nozzle 140. The core duct 142 is an annular duct positioned generally inward of the core cowl 122 along the radial direction R.

The fan section 150 includes a fan 152, which is the primary fan in this example. For the depicted example of FIG. 1, the fan 152 is an open rotor or unducted fan. However, in other examples, the fan 152 may be ducted, e.g., by a fan casing or nacelle circumferentially surrounding the fan 152. As depicted, the fan 152 includes an array of fan blades 154 (only one shown in FIG. 1). The fan blades 154 are rotatable, e.g., about the longitudinal axis 112. As noted above, the fan 152 is drivingly coupled with the low pressure turbine 134 via the LP shaft 138. The fan 152 can be directly coupled with the LP shaft 138, e.g., in a direct-drive configuration. Optionally, as shown in FIG. 1, the fan 152 can be coupled with the LP shaft 138 via a speed reduction gearbox 155, e.g., in an indirect-drive or a geared-drive configuration.

Moreover, the fan blades 154 can be arranged in equal spacing around the longitudinal axis 112. Each blade 154 has a root and a tip and a span defined therebetween. Each of the fan blades 154 defines a central blade axis 156. For this example, each blade 154 of the fan 152 is rotatable about its respective central blade axes 156, e.g., in unison with one another. One or more actuators 158 can be controlled to pitch the blades 154 about their respective central blade axes 156. However, in other examples, each of the fan blades 154 may be fixed or unable to be pitched about its central blade axis 156.

The fan section 150 further includes a fan guide vane array 160 that includes fan guide vanes 162 (only one shown in FIG. 1) disposed around the longitudinal axis 112. For this example, the fan guide vanes 162 are not rotatable about the longitudinal axis 112. Each fan guide vane 162 has a root and a tip and a span defined therebetween. The fan guide vanes 162 may be unshrouded as shown in FIG. 1 or may be shrouded, e.g., by an annular shroud spaced outward from the tips of the fan guide vanes 162 along the radial direction R. Each fan guide vane 162 defines a central blade axis 164. For this example, each fan guide vane 162 of the fan guide vane array 160 is rotatable about its respective central blade axes 164, e.g., in unison with one another. One or more actuators 166 can be controlled to pitch the fan guide vane 162 about their respective central blade axes 164. However, in other examples, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the gas turbine engine 100 includes both a ducted and an unducted fan that both serve to generate thrust through the movement of air without passage through core engine 120. The ducted fan 184 is shown at about the same axial location as the fan guide vane 162, and radially inward of the fan guide vane 162. Alternatively, the ducted fan 184 may be between the fan guide vane 162 and core duct 142, or be farther forward of the fan guide vane 162. The ducted fan 184 may be driven by the low pressure turbine 134 (e.g., coupled to the LP shaft 138), or by any other suitable source of rotation, and may serve as the first stage of booster or may be operated separately.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flow path or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The stationary struts 174 may each be aerodynamically contoured to direct air flowing thereby. Other struts in addition to the stationary struts 174 may be used to connect and support the fan cowl 170 and/or core cowl 122. In many examples, the fan duct 172 and the core cowl 122 may at least partially co-extend (generally axially) on opposite sides (e.g., opposite radial sides) of the core cowl 122. For example, the fan duct 172 and the core cowl 122 may each extend directly from the leading edge 144 of the core cowl 122 and may partially co-extend generally axially on opposite radial sides of the core cowl.

The gas turbine engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R.

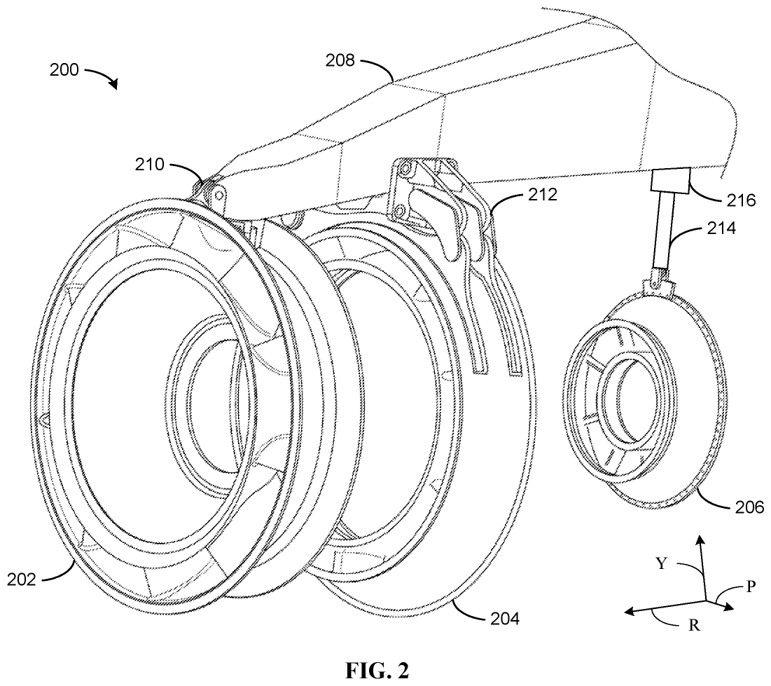

FIG. 2 is a perspective view of an example engine mount system 200 including a first frame portion 202, a second frame portion 204, and a third frame portion 206. In the illustrated example of FIG. 2, the frame portions 202, 204, 206 are coupled to a pylon 208 via a first forward mount 210, a second forward mount 212, and an aft mount 214 implemented in accordance with the teachings of this disclosure.

The frame portions 202, 204, 206 are portions of a frame of a gas turbine engine (e.g., the gas turbine engine 100 of FIG. 1, etc.). The frame portions 202, 204, 206 contain and/or support the components of the gas turbine engine and facilitate the coupling thereof to the pylon 208. In the illustrated example of FIG. 2, the first frame portion 202 is a forward frame portion (e.g., the forward frame, etc.), the second frame portion 204 is a midframe portion (e.g., the midframe, etc.), and the third frame portion 206 is a turbine vane frame portion (e.g., a turbine vane frame, etc.). Because the frame portions 202, 204, 206 are associated with the open rotor engine (e.g., the gas turbine engine 100 of FIG. 1, etc.), the frame packaging space within the frame portions 202, 204 (e.g., frame portions associated with the fan section 150, etc.) is limited by the fan blades. As such, in some examples, components that are typically supported by the forward frame portions 202, 204, such as the accessory gearbox and the oil tank, are supported by frame portions associated with the core engine 120 (e.g., the third frame portion 206, etc.).

In the illustrated example of FIG. 2, the first frame portion 202 is coupled to the pylon 208 via the first forward mount 210, the second frame portion 204 is coupled to the pylon 208 via the second forward mount 212, and the third frame portion 206 is coupled to the pylon 208 via the aft mount 214. In some examples, the first frame portion 202 and the second frame portion 204 are components of the fan section 150 of the gas turbine engine 100 of FIG. 1 (e.g., the first frame portion 202 is a first fan frame portion, the second frame portion 204 is a second fan frame portion, etc.) and the third frame portion 206 is a component of the core engine 120 of the gas turbine engine 100 of FIG. 1. It should be appreciated that a gas turbine engine including the frame portions 202, 204, 206 can include one or more additional frame portions disposed between ones of the frame portions 202, 204, 206.

In the illustrated example of FIG. 2, the third frame portion 206 is cantilevered (e.g., partially cantilevered, etc.) relative to the first frame portion 202 and the second frame portion 204. That is, the third frame portion 206 is primarily supported via a coupling (not illustrated) to the first frame portion 202 and the second frame portion 204. In some examples, as described above, the third frame portion 206 and/or other frame portions associated with the core section support components (e.g., the auxiliary gearbox (AGB), the oil tank, etc.) that are typically coupled within the fan frame portions (e.g., frame portions similar to the frame portions 204, 206, etc.). In some such examples, the additional weight of such components increases the gravitational load on the core section (e.g., the core engine 120, etc.). In the illustrated example of FIG. 2, to reduce (e.g., mitigate, etc.) potential distortions associated with the gravitational load on the core section, the engine mount system 200 includes the aft mount 214, which couples the third frame portion 206 to the pylon 208.

In the illustrated example of FIG. 2, the aft mount 214 includes an elastic element 216, which causes the aft mount 214 to have a lower stiffness than the forward mounts 210, 212. The comparatively low stiffness of the aft mount 214 enables some of the vertical load associated with the core engine 120 to be transferred to the pylon 208 via the aft mount 214, while reducing the transmission of bending moments through the core engine 120. In some examples, the aft mount 214 is a tuned mount. That is, in some examples, the material of the elastic element 216, the cross-sectional shape of the elastic element 216, and/or the thickness of the elastic element 216 can be selected (e.g., tuned, etc.) to balance the distortions associated with the gravitational loading (e.g., 1G loading, etc.) and the distortions associated with propeller loading (e.g., 1P loading, etc.). In some examples, the elastic element 216 damps vibrations transmitted between the pylon 208 and the core engine 120. In some examples, the elastic element 216 is a means for elastically coupling the core engine 120 and/or the third frame portion 206 to the pylon 208.

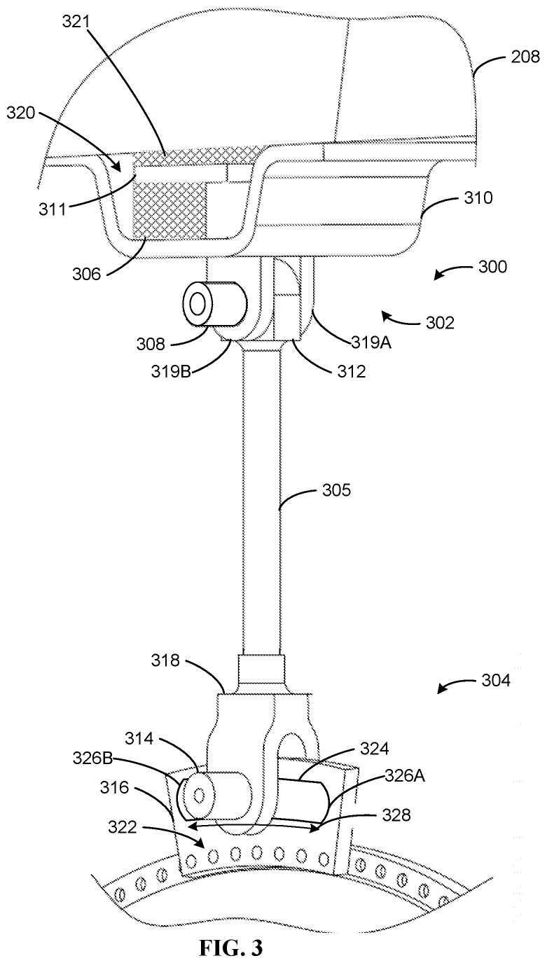

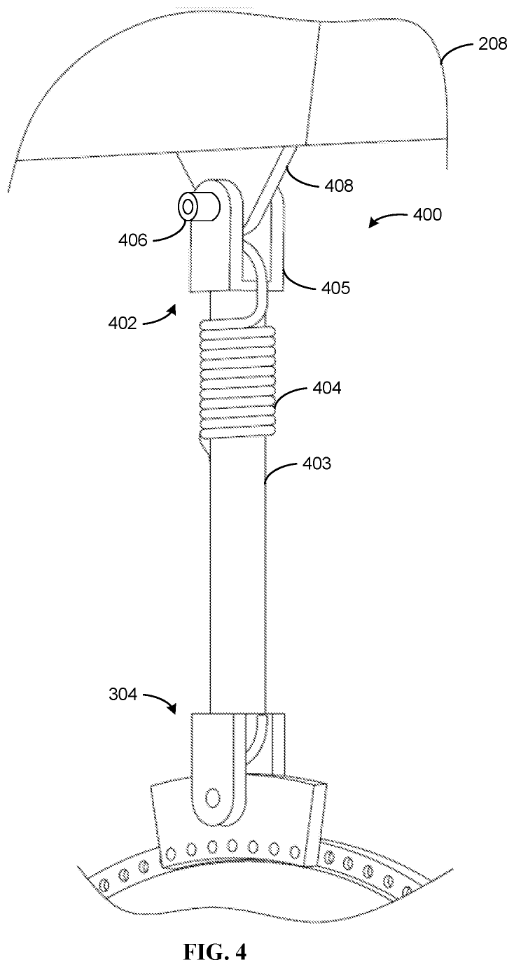

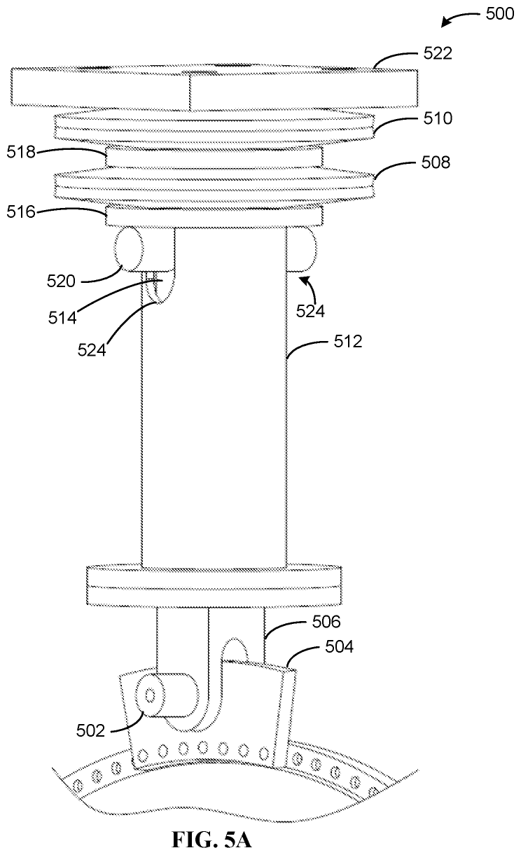

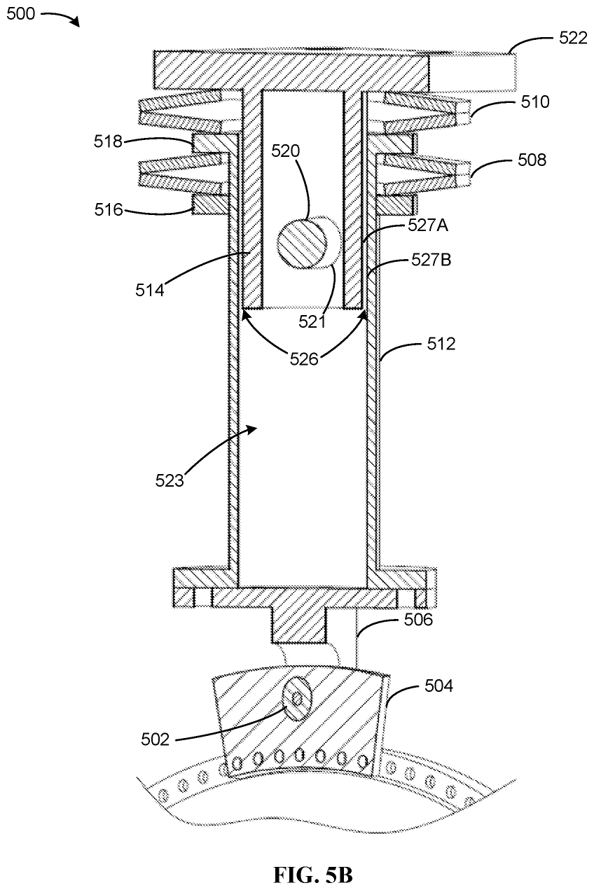

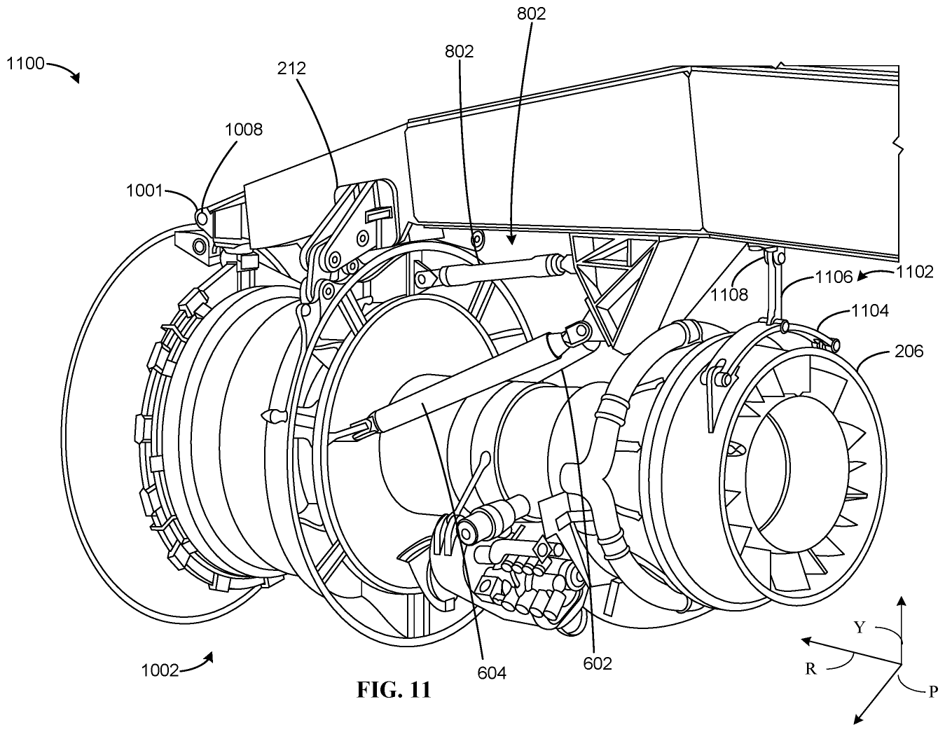

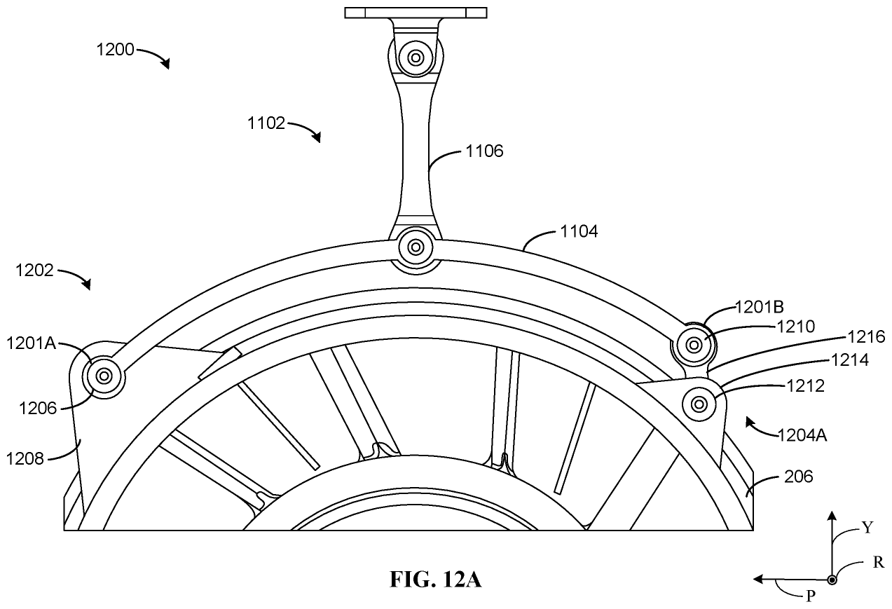

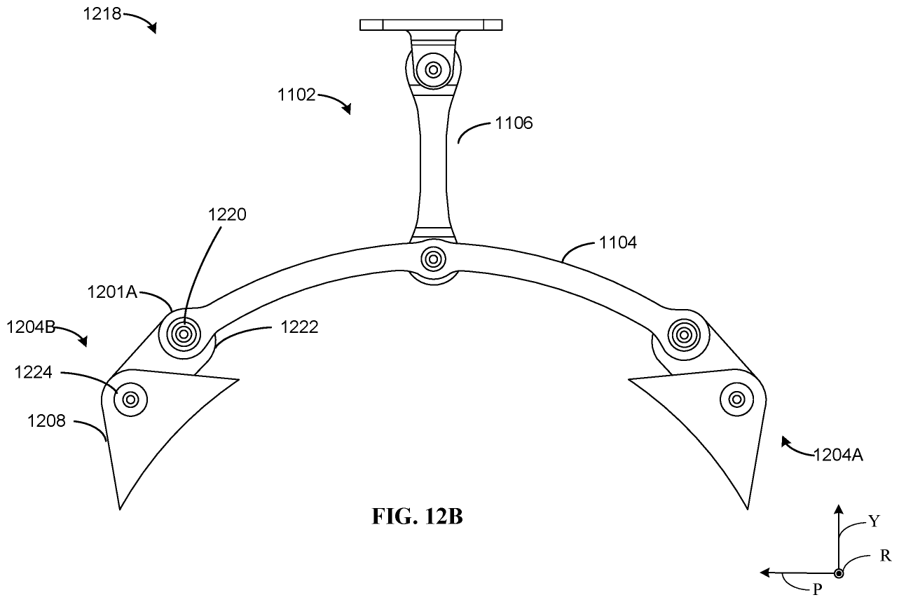

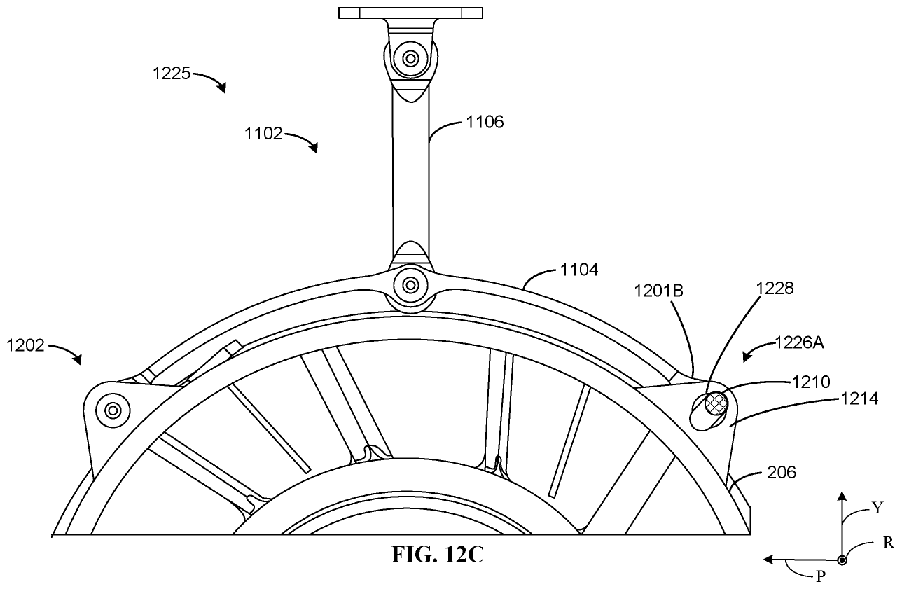

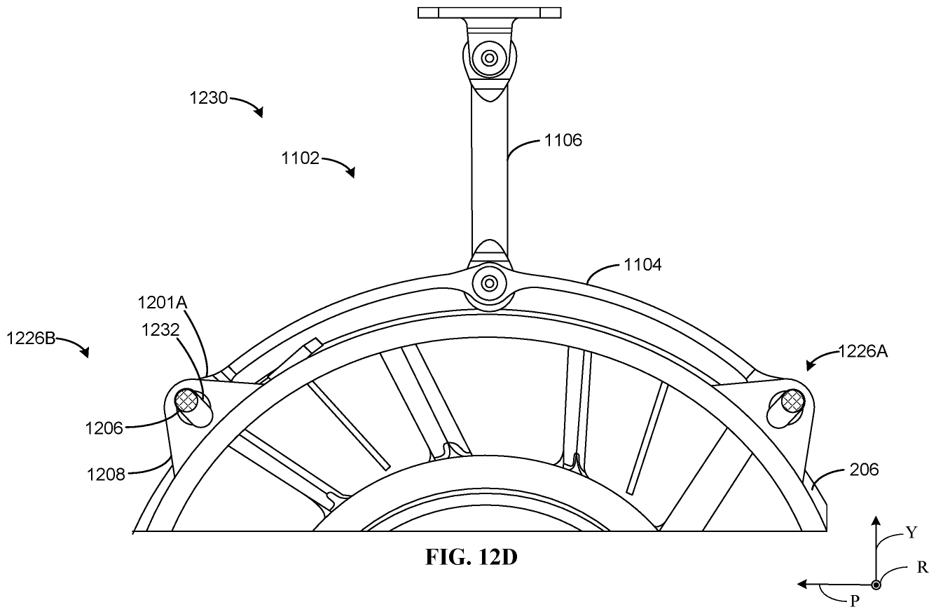

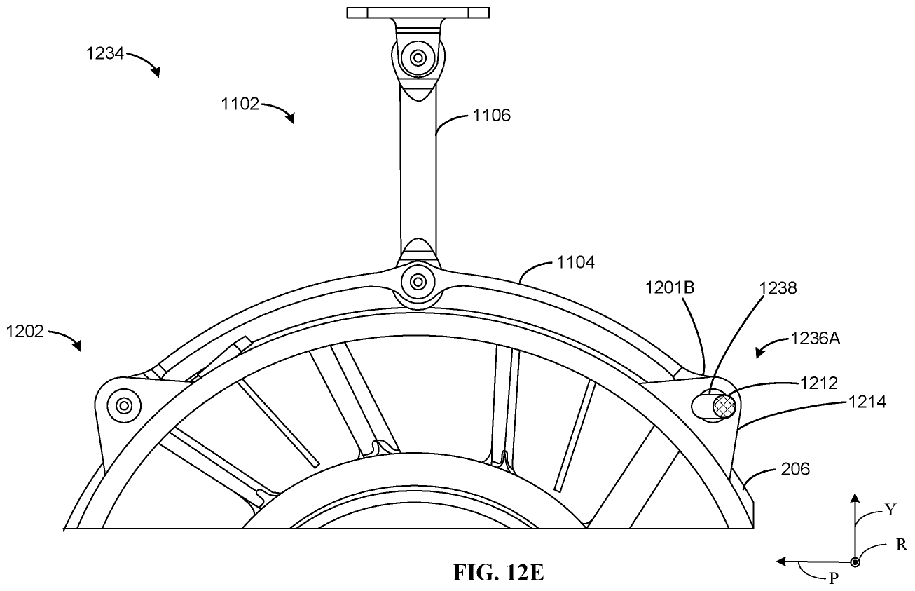

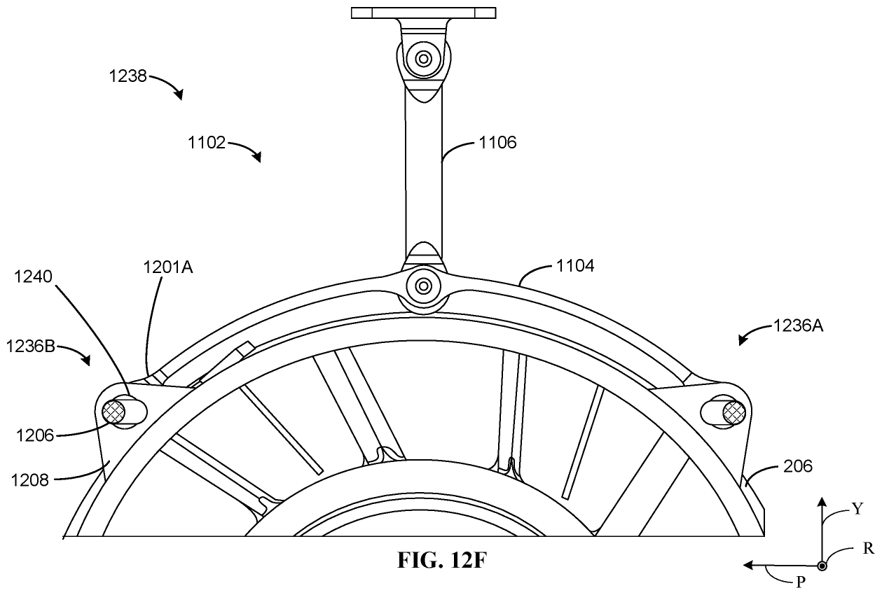

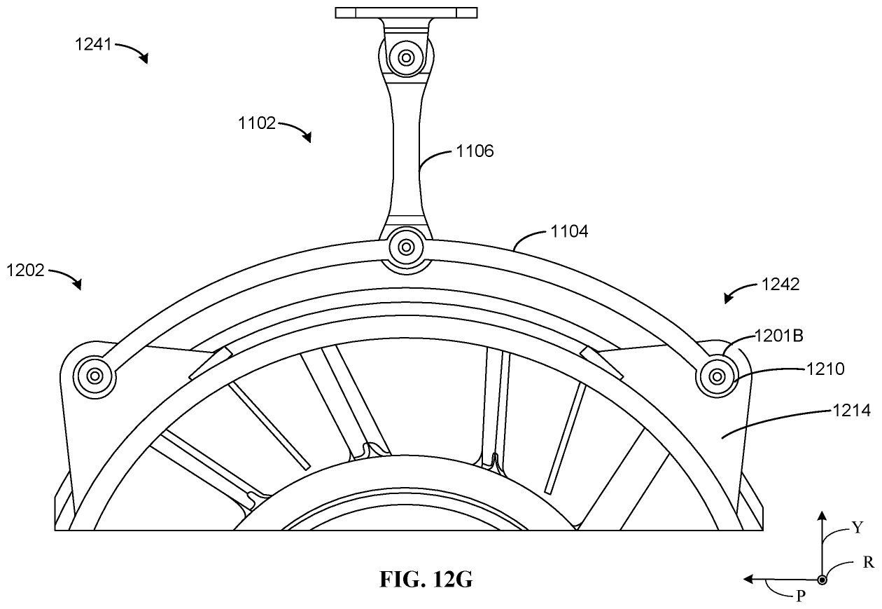

In the illustrated example of FIG. 2, the elastic element 216 includes an elastomer. The aft mount 214 and the elastic element 216 are described below in additional detail in conjunction with FIG. 3. Additionally or alternatively, the aft mount 214 can include a spring. For example, the aft mount 214 can include one or more tension coil springs, one or more hollow-tubing springs, one or more leaf springs, one or more volute springs, one or more gas springs (e.g., one or more air springs, etc.), one or more disc springs (e.g., one or more Belleville washers, etc.), etc. An example aft mount including a coil spring is described below in conjunction with FIG. 4. Another example aft mount including disc springs is described below in conjunction with FIGS. 5A and 5B. Other example aft mounts including leaf springs are described below in conjunction with FIG. 11-12F.

In some examples, the elastic element 216 can have an adjustable stiffness. For example, if the elastic element 216 is an air spring and/or a hydropneumatic spring, the stiffness can be adjusted based on the expected and/or sensed loads transferred via the aft mount 214. In some such examples, the stiffness of the elastic element 216 can be adjusted based on the ambient conditions of the engine mount system 200, the flight phase of the gas turbine engine 100, a property of the gas turbine engine 100, and/or a property of an aircraft propelled by the gas turbine engine 100.

In some examples, the aft mount 214 can include one or more features that enable the aft mount 214 to react yaw-moments (e.g., constrain the yaw-degree of freedom, etc.) during out-of-standard operations (e.g., during a blade-out event, etc.). For example, the aft mount 214 can include a slot that permits the relative rotation of the third frame portion 206 and the pylon 208 about the yaw-axis within an arc defined by the slot and constrains such rotation outside of the arc. In other examples, the aft mount 214 can include other features that enable the aft mount 214 to react yaw-moments (e.g., constrain the yaw-degree of freedom, etc.) during out-of-standard operations (e.g., during a blade-out event, etc.), while permitting such rotation during standard operation (e.g., expected flight phases, etc.). An example aft mount including such a feature is described below in conjunction with FIGS. 5A and 5B.

FIG. 3 is a perspective view of an example aft mount 300, which can implement the aft mount 214 of FIG. 2. In the illustrated example of FIG. 3, the aft mount 300 includes a pylon coupling 302, a frame coupling 304, and a structural member 305. In the illustrated example of FIG. 3, the pylon coupling 302 includes a first elastomer 306, a first pin 308, a bracket 310, a load plate 311, and a clevis 312. In the illustrated example of FIG. 3, the frame coupling 304 includes a second pin 314, a second plate 316, and a second yoke 318.

The pylon coupling 302 couples the aft mount 300 to the pylon 208. In the illustrated example of FIG. 3, the bracket 310 of the pylon coupling 302 is coupled to the pylon 208 (e.g., via one or more welds, via one or more fasteners, via one or more interference couplings, via one or more mechanical retainers, etc.). The clevis 312 of the pylon coupling 302 is an interface formed between the first elastomer 306 and the bracket 310. In the illustrated example of FIG. 3, the first pin 308 extends through the clevis 312. In the illustrated example of FIG. 3, the clevis 312 includes a first mounting plate 319A and a second mounting plate 319B. In the illustrated example of FIG. 3, the first pin 308 extends through openings in the mounting plates 319A, 319B, and the structural member 305, which forms an interface between the structural member 305 and the pylon coupling 302. The clevis 312 reacts vertical loads applied via the aft mount 300 and permits rotation of the structural member 305 about the first pin 308 extending through the clevis 312.

In the illustrated example of FIG. 3, the structural member 305 is a rigid structural member that extends between the pylon coupling 302 and the frame coupling 304 and reacts vertical loads transferred therebetween. The structural member 305 can be composed of any suitable rigid material, including steel, titanium, aluminum, a nickel alloy, etc. In the illustrated example of FIG. 3, the structural member 305 is coupled to the pylon coupling 302 via the clevis 312 and the first pin 308. The clevis 312 and the first pin 308 facilitate the rotation of the structural member 305 about the first pin 308 (e.g., about the roll axis, etc.).

The load plate 311 and first elastomer 306 are disposed with an interior 320 defined by coupling of the bracket 310 to the pylon 208. In the illustrated example of FIG. 3, the mounting plates 319A, 319B of the clevis 312 extend through openings in the bracket 310 and the first elastomer 306 and are coupled to the load plate 311. In some examples, the load plate 311 and the clevis 312 can be coupled via one or more welds, one or more fasteners, one or more interference couplings, etc. Additionally or alternatively, the load plate 311 and the clevis 312 are integral components. In the illustrated example of FIG. 3, the load plate 311 is not directly coupled to the bracket 310 and is able to translate therewithin. In some examples, the coupling of the clevis 312 and the load plate 311 retains the load plate 311 within the interior 320.

The first elastomer 306 is an elastic element disposed within the bracket 310, such that the first elastomer 306 reacts vertical loads (e.g., gravitational loads, aerodynamic loads, maneuver loads, etc.) applied downwardly on the aft mount 300. In the illustrated example of FIG. 2, the aft mount 300 includes a second elastomer 321 disposed between the top of the load plate 311 and the pylon 208. The second elastomer 321 reacts vertical loads (e.g., aerodynamic loads, maneuver loads, etc.) applied upwardly on the aft mount 300. The first elastomer 306 and/or the second elastomer 321 can be any suitable elastic material (e.g., natural rubber, isoprene rubber, silicone rubber, acrylic rubber, ethylene propylene rubber, a thermoplastic, etc.) with comparatively low stiffness (e.g., compared to the other component of aft mount 300, etc.).

The load plate 311 is movably disposed within the bracket 310. That is, the load plate 311 can translate vertically within the bracket 310 (e.g., toward the pylon 208, away from the pylon 208, etc.). During operation, downwardly applied vertical loads (e.g., a load applied in the negative direction along the yaw-axis, etc.), cause the load plate 311 to compress the first elastomer 306 and transfer the applied load thereto. In some such examples, the first elastomer 306 transfers the applied load to the bracket 310, which is then transferred to the pylon 208. Generally, the stiffness of the first elastomer 306 affects the portion of the negative vertical load associated with the gas turbine engine 100 transferred via the aft mount 300. That is, a greater stiffness of the first elastomer 306 causes a corresponding increase in the portion of the negative vertical loads (e.g., gravitational loads, maneuver loads, etc.) transferred via the aft mount 300 and a corresponding decrease in the portion of negative vertical loads applied via the other mounts associated with the gas turbine engine 100 (e.g., the forward mounts 210, 212 of FIG. 2, etc.).

During operation, upwardly applied vertical loads (e.g., a load applied in the positive direction along the yaw axis, etc.), cause the load plate 311 to move upward within the bracket 310, compress the second elastomer 321 and transfer the applied load thereto. In some such examples, the second elastomer 321 transfers the applied load to the pylon 208. Generally, the stiffness of the second elastomer 321 affects the portion of the positive vertical load associated with the gas turbine engine 100 transferred via the aft mount 300. That is, a greater stiffness of the second elastomer 321 causes a corresponding increase in the portion of the positive vertical loads (e.g., aerodynamic loads, maneuver loads, etc.) transferred via the aft mount 300 and a corresponding decrease in the portion of positive vertical loads applied via the other mounts associated with the gas turbine engine 100 (e.g., the forward mounts 210, 212 of FIG. 2, etc.). In some examples, the second elastomer 321 is absent. In some such examples, because the load plate 311 can freely translate in response to applied vertical loads, the aft mount 300 does not react positive vertical loads. In some examples, the geometries (e.g., the shape(s), the thickness(es), the presence of opening(s), etc.) and/or material of the first elastomer 306 and/or the second elastomer 321 can be selected to tune the portions of the negative vertical load and the positive vertical load, respectively, carried by the aft mount 300.

The frame coupling 304 couples the structural member 305 to the third frame portion 206. In the illustrated example of FIG. 3, the structural member 305 is coupled to the second yoke 318 (e.g., via one or more welds, one or more threaded connections, one or more fasteners, one or interference connections, etc.). Additionally or alternatively, the structural member 305 and the second yoke 318 can be integral.

The second plate 316 of the frame coupling 304 can be coupled to the third frame portion 206 via holes 322. For example, the second plate 316 can be coupled to the third frame portion 206 via one or more fasteners (e.g., one or more bolts, one or more screws, one or more rivets, etc.) extending through the holes 322. Additionally or alternatively, the second plate 316 can be coupled to the third frame portion via one or more welds, via one or more interference connections, etc. In other examples, the second plate 316 and the third frame portion 206 can be integral.

In the illustrated example of FIG. 3, the second pin 314 extends through a slot 324 of the second yoke 318 and the second plate 316. In the illustrated example of FIG. 3, the second plate 316, the second yoke 318, and the second pin 314 form a clevis, which facilitates the transferring of vertical loads between the third frame portion 206 and the structural member 305. The coupling of the structural member 305 and the third frame portion 206 via the second pin 314 facilitates the rotation of the structural member 305 about the second pin 314 (e.g., about the roll axis, etc.). In some such examples, the pins 308, 314 prevent the aft mount 300 from transferring moments about the roll axis.

In the illustrated example of FIG. 3, the slot 324 of the second plate 316 includes a first end 326A and a second end 326B. In the illustrated example of FIG. 3, the slot 324 defines an example arc 328 between the ends 326A, 326B. During standard operation (e.g., takeoff, cruise, descent, landing, etc.), the second pin 314 slides within the slot 324, which prevents the aft mount 300 from reacting yaw moments. In some examples, yaw moments can be generated by 1P loading. In some such examples, because the aft mount 300 does not react yaw moments during standard operation, operational distortions associated with 1P loading transferred via the aft mount 300 can be reduced. In some examples, during non-standard operation (e.g., a blade-out event, etc.), the yaw moment applied through the gas turbine engine 100 can increase and cause the gas turbine engine 100 to rotate such that the second pin 314 abuts one of the ends 326A, 326B. In some such examples, the contact between the second pin 314 and one of the ends 326A, 326B causes the aft mount 300 to react yaw moments, which can mitigate the impact of such non-standard operation. In other examples, the slot 324 can be absent. In some such examples, the second plate 316 can include a hole to receive the second pin 314.

FIG. 4 is a perspective view of another example aft mount 400 implemented in accordance with the teachings of this disclosure. The aft mount 400 can be used to implement the aft mount 214 of FIG. 2. In the illustrated example of FIG. 4, the aft mount 400 includes a pylon coupling 402, the frame coupling 304 of FIG. 3, a structural member 403, and a spring 404. The example aft mount 400 is similar to the aft mount 300 of FIG. 3, except that aft mount 400 includes the spring 404 instead of the first elastomer 306. While the aft mount 400 does not include a slot in the illustrated example of FIG. 4, in other examples, the aft mount 400 can include a slot similar to the slot 324 of FIG. 3.

In the illustrated example of FIG. 4, the pylon coupling 402 includes a yoke 405, a pin 406, and a mounting plate 408. In the illustrated example of FIG. 4, the structural member 403 is coupled to the yoke 405 (e.g., via one or more welds, one or more threaded connections, one or more fasteners, one or more interference connections, etc.). Additionally or alternatively, the structural member 403 and the yoke 405 can be integral. In the illustrated example, the mounting plate 408 extends from the pylon 208 and facilitates the coupling of the aft mount 400 thereto. In the illustrated example of FIG. 4, the pin 406 extends through the yoke 405 and the mounting plate 408. In the illustrated example of FIG. 3, the mounting plate 408, the yoke 405, and the pin 406 form a clevis, which facilitates the transferring of vertical loads between the third frame portion 206 and the structural member 403. The coupling of the structural member 403 and the third frame portion 206 via the pin 406 facilitates the rotation of the structural member 403 about the pin 406 (e.g., about the roll axis, etc.). In some such examples, the pin 406 and the frame coupling 304 (e.g., the second pin 314 of FIG. 3, etc.) prevent the aft mount 400 from transferring moments about the roll axis.

The spring 404 is a coil spring (e.g., a helical spring, etc.) that resists tension applied between the pylon coupling 302 and the frame coupling 304. In the illustrated example of FIG. 4, the spring 404 is disposed in the load path between the pylon coupling 402 and the frame coupling 304, such that the spring 404 reacts negative vertical loads (e.g., gravitational loads, aerodynamic loads, maneuver loads, etc.) transferred between the pylon coupling 402 and the frame coupling 304. In some examples, the spring 404 does not react positive vertical loads between the pylon coupling 402 and the frame coupling 304.

In some examples, the aft mount 400 can include additional structural members (not illustrated) disposed between the pylon coupling 302 and the frame coupling 304. In some examples, the geometry and/or material of the spring 404 can be selected to reduce the distortion associated with gravitational and maneuver loading and to reduce the distortion associated with bending moments transferred between the aft mount 400 and the forward mounts of the gas turbine engine (e.g., the forward mounts 210, 212, etc.). In some examples, the material can be any suitable material, including spring steel, titanium, nickel-alloy, composite, and/or any other suitable material.

FIG. 5A is a perspective view of another example aft mount 500 implemented in accordance with the teachings of this disclosure. FIG. 5B is a cross-sectional view of the aft mount 500. The aft mount 500 can implement the aft mount 214 of FIG. 2. In the illustrated example of FIGS. 5A and 5B, the aft mount 500 includes a first pin 502, a plate 504, and a yoke 506 similar to the second pin 314 of FIG. 3, the second plate 316 of FIG. 3, and the second yoke 318 of FIG. 3. For example, the plate 504 can be coupled to a frame portion of the core engine 120 (e.g., the third frame portion 206, etc.) in a manner similar to the frame coupling 304 of FIGS. 3 and 4. In other examples, the aft mount 500 can be coupled to the core engine 120 via any other suitable coupling.

In the illustrated example of FIGS. 5A and 5B, the aft mount 500 includes a first disc spring 508, a second disc spring 510, a first structural member 512, a second structural member 514, a first flange 516, a second flange 518, a second pin 520, and a mounting plate 522. In the illustrated example of FIGS. 5A and 5B, each of the disc springs 508, 510 include two frustoconical portions. In other examples, one or both of the disc springs 508, 510 can have any other suitable shape (e.g., a conical shape, a frustoconical shape, etc.). In the illustrated example of FIGS. 5A and 5B, each of the disc springs 508, 510 is a single spring. In other examples, one or both of the disc springs 508, 510 can include one or more portions stacked in parallel and/or one or more portions stacked in sequence. In some examples, the thickness of the portions of the disc springs 508, 510, and/or the quantity thereof can be used to adjust the stiffness of the aft mount 500 in the negative vertical direction and the positive vertical direction, respectively. In the illustrated example of FIGS. 5A and 5B, the disc springs 508, 510 are composite springs. In other examples, the disc springs 508, 510 can be composed of any other suitable material (e.g., steel, aluminum, a nickel alloy, bronze, etc.).

The first structural member 512 is a rigid structural member (e.g., a tubular member, a tube, etc.) that transfers load between the yoke 506 and one or both of the disc springs 508, 510. In the illustrated example of FIGS. 5A and 5B, the first structural member 512 has a generally circular cross-section. In other examples, the first structural member 512 can have any other suitable cross-section (e.g., an ovoid cross-section, a polygonal cross-section, etc.). The first structural member 512 can be composed of any suitable rigid material including steel, titanium, aluminum, a nickel alloy, a composite, etc. In the illustrated example of 5B, the first structural member 512 has an interior 523, which receives the second structural member 514.

The second structural member 514 is a rigid structural member (e.g., a tubular member, a tube, etc.) that transfers load between the mounting plate 522 and one or both of the disc springs 508, 510. In the illustrated example of FIG. 5B, the second structural member 514 has a same cross-sectional shape as the first structural member 512 and has a smaller cross-sectional size than the first structural member 512 such that a gap 526 is formed between an outer diameter 527A of the second structural member 514 and an inner diameter 527B of the first structural member 512. The second structural member 514 can be composed of any suitable rigid material including steel, titanium, aluminum, a nickel alloy, a composite, etc.

The first flange 516 is an annular member disposed between the second pin 520 and the first disc spring 508. In the illustrated example of FIGS. 5A and 5B, the first flange 516 is not fixedly coupled to the first structural member 512 or the second structural member 514 and is retained in compression between the second pin 520 and the first disc spring 508. The first flange 516 can be composed of any suitable rigid material including steel, titanium, aluminum, a nickel alloy, a composite, etc. In some examples, the first flange 516 is a washer and/or a circular disc. In other examples, the first flange 516 can be any other suitable shape. The second flange 518 is an annular member disposed between the first disc spring 508 and the second disc spring 510. In the illustrated example of FIGS. 5A and 5B, the second flange 518 is integral with the first structural member 512. In other examples, the second flange 518 can be an annular member coupled to the first structural member 512 via one or more welds, via one or more fasteners (e.g., bolts, screws, rivets, etc.), via one or more interface connections, and/or via one or more mechanical interfaces. In some examples, the second flange 518 is composed of a same material as the first structural member 512. In other examples, the second flange 518 can be composed of a different rigid material.

The second pin 520 couples the first structural member 512 and the second structural member 514. In the illustrated example of FIGS. 5A and 5B, the second pin 520 abuts the first flange 516, which retains the coupling of the first structural member 512 to the second structural member 514. In the illustrated example of FIGS. 5A and 5B, the first structural member includes slots 524. In the illustrated example of FIGS. 5A and 5B, the second pin 520 extends through the slots 524 and openings 521 in the second structural member 514.

The mounting plate 522 enables the aft mount 500 to be coupled to a pylon (e.g., the pylon 208 of FIG. 2, etc.). For example, the mounting plate 522 can be coupled to a pylon 208 via one or more welds, via one or more fasteners (e.g., bolts, screws, rivets, etc.), via one or more interface connections, and/or via one or more mechanical interfaces. In other examples, the mounting plate 522 can be integral with a pylon and/or a portion of a pylon. In the illustrated example of FIG. 5B, the mounting plate 522 and the second structural member 514 are integral. In other examples, the mounting plate 522 can be coupled to the second structural member 514 via one or more welds, via one or more fasteners (e.g., bolts, screws, rivets, etc.), via one or more interface connections, and/or via one or more mechanical interfaces.

During operation, the slots 524 permit the vertical translation of the first structural member 512 relative to the second structural member 514 and the second pin 520. For example, during positive vertical loads (e.g., the gas turbine engine 100 is pushing upwards on the pylon 208, a compression load, etc.), the second pin 520 slides downward within the slots 524 until the second pin 520 abuts a bottom of the slots 524, which enables the compression of the second disc spring 510. The compression of the second disc spring 510 reduces the stiffness of the aft mount 500 in tension, which reduces the portion of positive vertical load associated with the gas turbine engine 100 transferred via the aft mount 500 and increases the portion of positive vertical loads transferred via the other mounts of the gas turbine engine 100. In some examples, the second disc spring 510 is absent. In some such examples, the aft mount 500 can include a rigid connection to react positive vertical loads.

During operation, if a negative vertical load is applied to the aft mount 500 (e.g., the gas turbine engine 100 is pulling downwards on the pylon 208, a tension load, etc.), the second flange 518 applies a compressive load to the first disc spring 508. In some such examples, the first disc spring 508 is compressed between the second flange 518 and the first flange 516. The compression of the first disc spring 508 reduces the stiffness of the aft mount 500 in compression, which reduces the portion of negative vertical load associated with the gas turbine engine 100 transferred via the aft mount 500 and increases the portion of negative vertical loads transferred via the other mounts of the gas turbine engine 100. In some examples, the first disc spring 508 is absent. In some such examples, the aft mount 500 can include a rigid connection to react negative vertical loads.

The gap 526 enables the relative rotation of the first structural member 512 and the second structural member 514 about the second pin 520. During standard operation (e.g., takeoff, cruise, descent, landing, etc.), the second structural member 514 rotates within the interior 523 about the second pin 520, which prevents the aft mount 500 from reacting yaw moments. In some examples, yaw moments can be generated by 1P loading. In some such examples, because the aft mount 500 does not react yaw moments during standard operation, operational distortions associated with 1P loading transferred via the aft mount 214 can be reduced. In some examples, during non-standard operation (e.g., a blade-out event, etc.), the yaw moment applied through the gas turbine engine 100 can increase and cause the gas turbine engine 100 to rotate such that the second structural member 514 rotates within the gap 526 until the outer diameter 527A of the second structural member 514 abuts the inner diameter 527B of the first structural member 512. In some such examples, the contact between the second structural member 514 and the first structural member 512 causes the aft mount 500 to react yaw moments, which can mitigate the impact of such non-standard operation. In other examples, the gap 526 can be absent and the aft mount 500 can react yaw moments during standard operation.

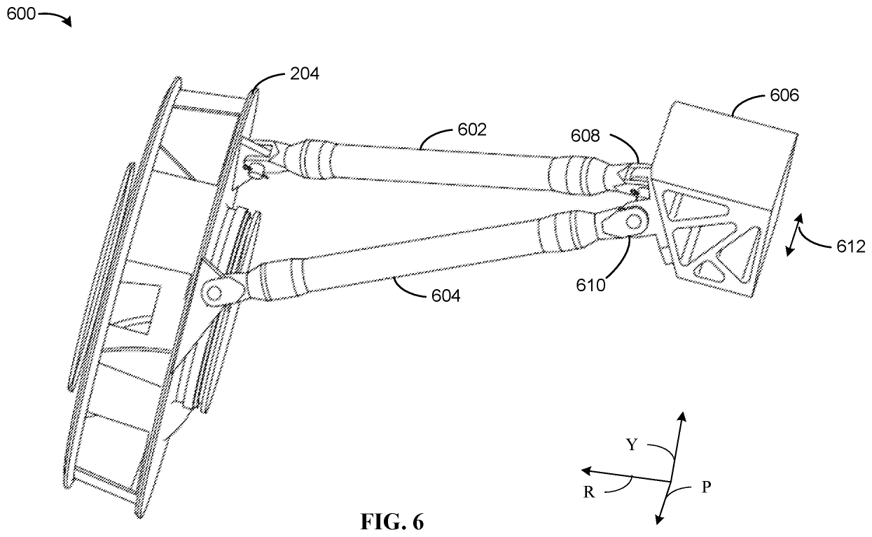

FIG. 6 is a perspective view of an example first thrust linkage configuration 600 that can be used in conjunction with the second frame portion 204 of FIG. 2. In the illustrated example of FIG. 6, the first thrust linkage configuration 600 includes a first thrust linkage 602 and a second thrust linkage 604, which extend between the second frame portion 204 of FIG. 2 and a pylon block 606. In the illustrated example of FIG. 6, the first thrust linkage 602 is coupled to the pylon block 606 at a first block attachment point 608 and the second thrust linkage 604 is coupled to the pylon block 606 at a second block attachment point 610.

The pylon block 606 is a mounting component that is coupled to a pylon supporting the second frame portion 204 (e.g., the pylon 208 of FIG. 2, etc.). In some examples, the pylon block 606 can be absent. In some such examples, the thrust linkages 602, 604 can extend directly to the pylon 208. In some examples, an aft mount (e.g., one of the aft mounts 214, 400, 500 of FIGS. 2-5B, etc.) can be coupled to the pylon block 606.

The first thrust linkage configuration 600 enables the yaw moment generated by the operation of a gas turbine engine including the second frame portion 204 (e.g., the gas turbine engine 100 of FIG. 1, etc.) to be constrained by the thrust linkages 602, 604 in combination. The thrust linkages 602, 604 prevent yaw moments from being transferred through the cantilevered core. In the illustrated example of FIG. 6, the thrust linkages 602, 604 transfer axial forces between the second frame portion 204 to the pylon block 606. In some examples, either or both of the thrust linkages 602, 604 can be implemented by multiple thrust linkages (e.g., two thrust linkages, three thrust linkages, etc.). In some such examples, the plurality of linkages implementing the first thrust linkage 602 can be joined together via a yoke and/or a whiffletree connection, which evenly distributes the load between each of the plurality of linkages. In some such examples, the plurality of linkages implementing the second thrust linkage 604 can be joined together via a yoke and/or whiffletree connection, which evenly distributes the load between each of the plurality of thrust linkages.

The block attachment points 608, 610 of the thrust linkages 602, 604 on the pylon block 606 are separated by a lateral displacement 612. The lateral displacement 612 enables the thrust linkages 602, 604 to bear different amounts of axial loads generated by the gas turbine engine 100. As such, this imbalance of axial forces between the thrust linkages 602, 604 enables the thrust linkages to transfer yaw moments generated by the gas turbine engine 100 between the second frame portion 204 and the pylon block 606.

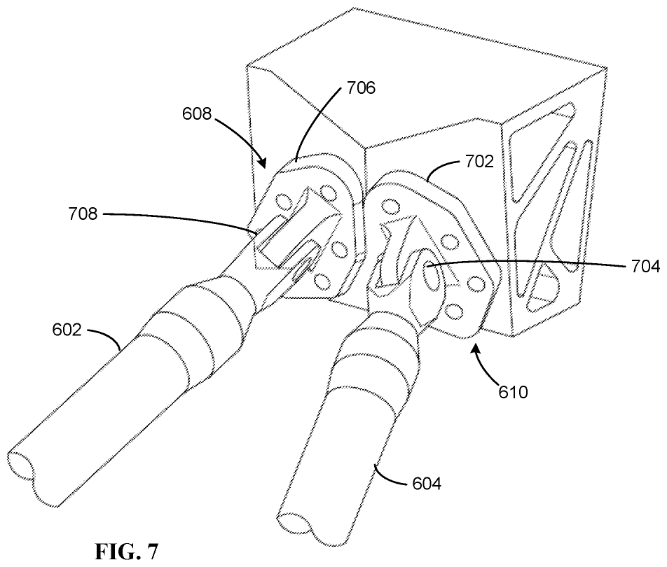

FIG. 7 is a perspective view of the coupling between the thrust linkages 602, 604 of FIG. 6 to the pylon block 606 of FIG. 6. In the illustrated example of FIG. 7, the first thrust linkage 602 is coupled to a first lug 702 via a first pin 704, and the second thrust linkage 604 is coupled to a second lug 706 via a second pin 708. In the illustrated example of FIG. 7, the lugs 702, 706 are discrete components that can be coupled to the pylon block 606 via one or more fasteners (e.g., bolts, rivets, etc.). In other examples, one or both of the lugs 702, 706 can be integral with the pylon block 606. In some examples, one or both of the pins 704, 708 can include and/or be coupled to one or more bearings and/or bushings. In some such examples, the bearings and/or bushings can prevent non-axial forces from being reacted via the thrust linkages 602, 604.

In the illustrated example of FIG. 7, the block attachment points 608, 610 independently couple the thrust linkages 602, 604 to the pylon block 606. That is, unlike some prior connections, the thrust linkages 602, 604 are not coupled via a yoke, such as a whiffletree connection, and are directly coupled to the pylon block 606. As such, the thrust linkages 602, 604 are capable of reacting with different amounts of axial force, which enables the thrust linkages 602, 604 to react yaw moments between the second frame portion 204 and the pylon block 606.

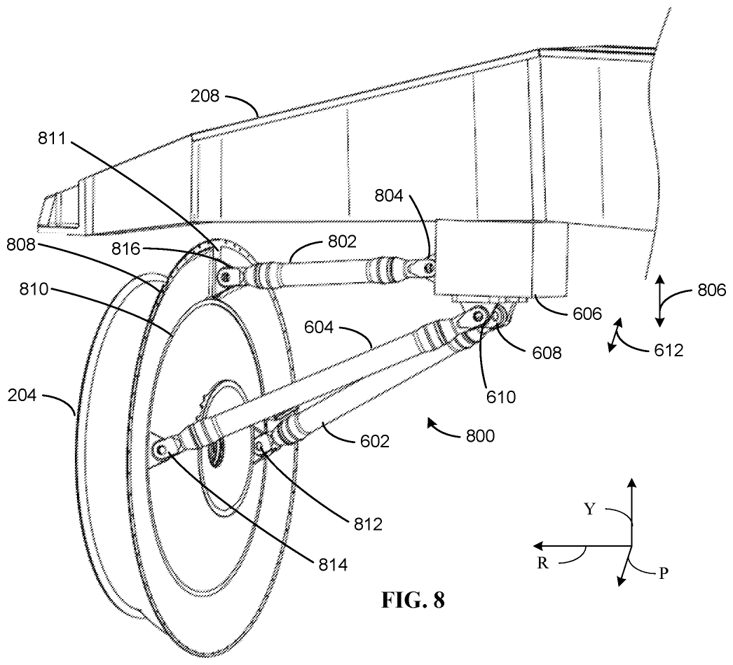

FIG. 8 is a perspective view of an example second thrust linkage configuration 800 that can be used in conjunction with the second frame portion 204 of FIG. 2. In the illustrated example of FIG. 8, the second thrust linkage configuration 800 includes the first thrust linkage 602 of FIG. 6, the second thrust linkage 604 of FIG. 6, and a third thrust linkage 802. In the illustrated example of FIG. 8, the third thrust linkage 802 is coupled to the pylon block 606 of FIG. 6 at a third block attachment point 804. The second thrust linkage configuration 800 enables both yaw and pitch moments generated by the operation of a gas turbine engine (e.g., the gas turbine engine 100, etc.) to be constrained by the thrust linkages 602, 604, 802, which mitigates lateral and vertical displacements of the cantilevered core of the gas turbine engine. In the illustrated example of FIG. 8, the pylon block 606 is coupled to the pylon 208. In the illustrated example of FIG. 8, the second frame portion 204 includes an outer ring 808, an inner ring 810, and a bifurcation 811. In the illustrated example, the first thrust linkage 602 is coupled to the inner ring 810 at a first frame attachment point 812, the second thrust linkage 604 is coupled to the inner ring 810 at a second frame attachment point 814, and the third thrust linkage 802 is coupled to the bifurcation 811 at the third frame attachment point 816.

In the illustrated example of FIG. 8, the thrust linkages 602, 604, 802 transfer axial forces generated by the second frame portion 204 to the pylon block 606 and the pylon 208. The block attachment points 608, 610 of the thrust linkage 602, 604, and the third block attachment point 804 of the third thrust linkage 802 are separated by a vertical displacement 806. Similarly, the thrust linkages 602, 604 are separated by the lateral displacement 612 of FIG. 6. The vertical displacement 806 and the lateral displacement 612 allow imbalances of axial forces to occur between the thrust linkages 602, 604, 802. As such, the thrust linkages 602, 604, 802 can transfer yaw and pitch moments associated with the second frame portion 204 to the pylon 208 (e.g., via the pylon block 606, etc.). In other examples, the thrust linkages 602, 604, 802 can have any other suitable (e.g., having both vertical and lateral displacements, etc.).

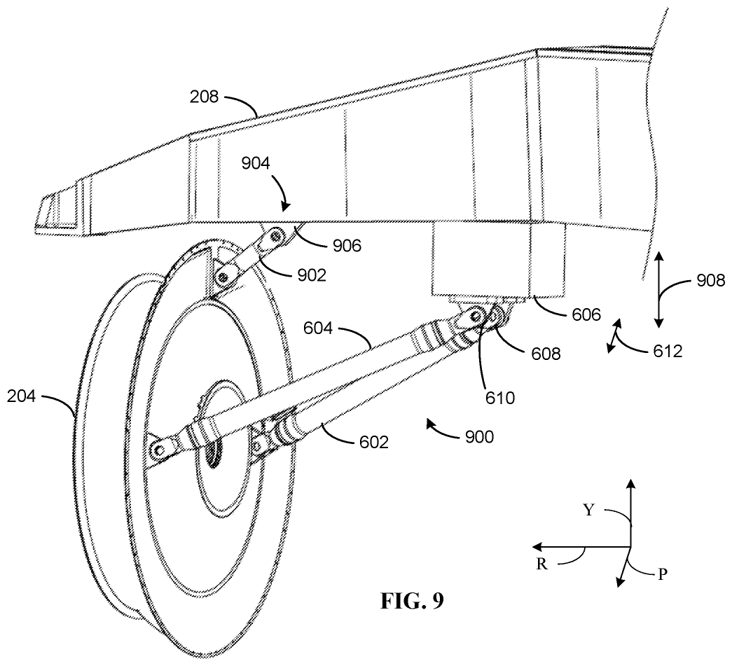

FIG. 9 is a perspective view of an example third thrust linkage configuration 900 that can be used in conjunction with the second frame portion 204 of FIG. 2. In the illustrated example of FIG. 9, the third thrust linkage configuration 900 includes the first thrust linkage 602 of FIG. 6, the second thrust linkage 604 of FIG. 6, and a third thrust linkage 902. In the illustrated example of FIG. 9, the third thrust linkage 902 is coupled to the pylon 208 at a third block attachment point 904. The example third thrust linkage configuration 900 is similar to the second thrust linkage configuration 800, except that the third thrust linkage 902 is coupled directly to the pylon 208 via a lug 906 unlike the third thrust linkage 802 of FIG. 8, which is coupled to the pylon block 606.

In the illustrated example of FIG. 9, the thrust linkages 602, 604, 902 transfer axial forces generated by the second frame portion 204 to the pylon block 606 and the pylon 208. The block attachment points 608, 610 of the thrust linkage 602, 604, and the third attachment point 904 of the third thrust linkage 802 are separated by a vertical displacement 908. Similarly, the thrust linkages 602, 604 are displacement by the lateral displacement 612 of FIG. 6. The vertical displacement 908 and the lateral displacement 612 allow imbalances of axial forces to occur between the thrust linkages 602, 604, 902. As such, the thrust linkages 602, 604, 902 can transfer yaw and pitch moments associated with the second frame portion 204 to the pylon 208 (e.g., via the pylon block 606, etc.). In other examples, the thrust linkages 602, 604, 902 can have any other suitable configuration (e.g., having both vertical and lateral displacements, etc.).

The first thrust linkage configuration 600 of FIGS. 6 and 7, the second thrust linkage configuration 800 of FIG. 8, and the third thrust linkage configuration 900 are configurations that react yaw and/or pitch moments and mitigate lateral and/or vertical displacements of the cantilevered core sections associated therewith. In some examples, the first thrust linkage configuration 600 of FIGS. 6 and 7, the second thrust linkage configuration 800 of FIG. 8, and/or the third thrust linkage configuration 900 can be used in conjunction with the aft mount 214 of FIGS. 2 and 3, the aft mount 400 of FIG. 4 and/or aft mount 500 of FIGS. 5A and 5B. In some such examples, because the thrust linkage configurations 600, 800, 900 of FIGS. 6-9 react yaw and/or pitch moments transmitted through the gas turbine engine and prevent the aft mounts 214, 400, 500 from reacting yaw and pitch moments. In some such examples, by preventing the aft mounts 214, 400, 500 from reacting yaw and pitch moments, operational distortions in the engine carcass are reduced (e.g., eliminated, etc.).

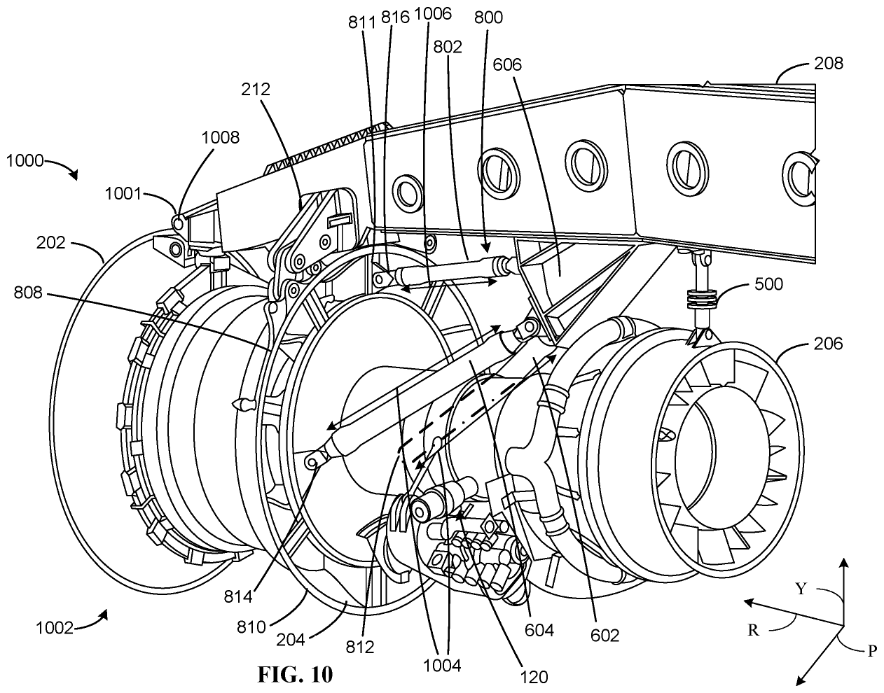

In some examples, frame mount systems including the thrust linkage configurations 600, 800, 900 of FIGS. 6-9 can be over constrained and/or statically indeterminate. In some such examples, the thermal expansion of the thrust linkage configurations 600, 800, 900 can cause engine carcass distortions due to stress and strain associated with the expansion of the thrust linkages of the thrust linkage configurations 600, 800, 900. Example mount systems to mitigate such thermal expansion-associated distortions are described below in conjunction with FIGS. 10 and 11.

FIG. 10 is a perspective view of another example engine mount system 1000 including the aft mount 500 of FIGS. 5A and 5B, the second thrust linkage configuration 800 of FIG. 8, a first forward mount 1001, and the second forward mount 212 of FIG. 2. In the illustrated example of FIG. 10, the engine mount system 1000 couples a gas turbine engine 1002 to the pylon 208. The gas turbine engine 1002 includes the core engine 120 of FIG. 1 and the frame portions 202, 204, 206 of FIG. 2. The gas turbine engine 1002 is similar to the gas turbine engine 100 of FIG. 1, except as otherwise noted.

In the illustrated example of FIG. 10, the aft mount 500 extends between the pylon 208 and the third frame portion 206. In the illustrated example of FIG. 10, the first forward mount 1001 extends between the pylon 208 and the first frame portion 202. In the illustrated example of FIG. 10, the first thrust linkage 602 of the second thrust linkage configuration 800 of FIG. 8 is coupled to the second frame portion 204 at the first frame attachment point 812, the second thrust linkage 604 of the second thrust linkage configuration 800 is coupled to the second frame portion 204 at the second frame attachment point 814, and the third thrust linkage 802 of the second thrust linkage configuration 800 is coupled to the second frame portion 204 at the third frame attachment point 816. In the illustrated example of FIG. 10, the first thrust linkage 602 and the second thrust linkage 604 have a first length 1004 and the third thrust linkage 802 has a second length 1006.

In the illustrated example of FIG. 10, the engine mount system 1000 over constrains the gas turbine engine 100. That is, the mounting components of the engine mount system 1000 (e.g., the forward mounts 212, 1001, the aft mount 500, the first thrust linkage 602, the second thrust linkage 604, the third thrust linkage 802, etc.) include 9 static constraints. For example, forward mounts 212, 1001 constrain lateral translation, vertical translation, longitudinal translation, yaw translation, and roll rotation, the thrust linkages 602, 604, 802 constrain longitudinal translation, yaw rotation, and pitch translation, and the aft mount 500 constrains vertical translation. In other examples, depending on the configuration of the forward mounts 212, 1001, the aft mount 500, the first thrust linkage 602, the second thrust linkage 604, the third thrust linkage 802, the engine mount system 1000 can include fewer static constraints (e.g., 6 static constraints, 7 static constraints, 8 static constraints, etc.) and/or additional static constraints (e.g., 10 static constraints, etc.). As such, because the engine mount system 1000 includes more than 6 static constraints, the engine mount system 1000 is statically indeterminate (e.g., over constrained, statically overdetermined, unresolvable via force and moment balancing, etc.). Because the engine mount system 1000 is statically indeterminate, the loads carried by the forward mounts 212, 1001, the aft mount 500, the first thrust linkage 602, the second thrust linkage 604, and the third thrust linkage 802 are dependent on the ambient conditions (e.g., temperature, etc.) material properties (e.g., stiffness, thermal properties, etc.), and the geometry (e.g., the length, the thickness, etc.) of the forward mounts 212, 1001, the aft mount 500, the first thrust linkage 602, the second thrust linkage 604, the third thrust linkage 802.

During the operation of the gas turbine engine 1002, a portion of the air that enters the gas turbine engine 1002 flows through the core engine 120. Within the core engine 120, the air is pressurized (e.g., via the LP compressor 126 and the HP compressor 128 of FIG. 1, etc.) and combusted (e.g., via the combustor 130, etc.). The comparably hot and dense air increases the relative temperature of the core engine 120 and components of the gas turbine engine 1002 adjacent to the core engine 120 when compared to other components of the gas turbine engine 1002. Additionally, during the operation of the gas turbine engine 1002, ambient air (e.g., about −50 degrees Fahrenheit at operational altitudes, etc.) passes between the inner ring 810 and the outer ring 808, which is cooler than the air flowing through the core engine 120 (e.g., about 3000 degrees Fahrenheit, etc.). In the illustrated example of FIG. 10, the frame attachment points 812, 814 and the block attachment points 608, 610 of the first thrust linkage 602 and the second thrust linkage 604 are closer to the core engine 120 than the third frame attachment point 816 and the third block attachment point 804 of the third thrust linkage 802. As such, the first thrust linkage 602 and the second thrust linkage 604 are closer to the core engine 120 than the third thrust linkage 802. The closer proximity of the thrust linkages 602, 604 to the core engine 120 and the position of the third thrust linkage 802 on the bifurcation 811 causes the operational temperatures of the thrust linkage 602, 604 to be greater than the operational temperature of the third thrust linkage 802.

The linear expansion of a component due to a temperature change is set forth in Equation (1):

$$Δ L = α L Δ T \qquad ( 1 )$$

where ΔL is the change in length, α is the linear coefficient of thermal expansion for the material of the component, L is the original length of the component, and ΔT is the change in temperature of the component. In the illustrated example of FIG. 10, the first length 1004 of the thrust linkages 602, 604 is greater than the second length 1006 of the third thrust linkage 802. Because the thrust linkages 602, 604 are greater in length (e.g., a greater L, etc.) and are subjected to a larger temperature change than the third thrust linkage 802 (e.g., a greater ΔT, etc.), the thrust linkages 602, 604 are more susceptible to thermal expansion (e.g., a greater ΔL, etc.) than the third thrust linkage 802 during operation of the gas turbine engine 100. In some examples, a greater thermal expansion of the thrust linkages 602, 604 than the third thrust linkage 802 can create a bending stress in the second frame portion 204 and/or distortions in the core engine 120. For example, the thermal expansion of the thrust linkages 602, 604, 802 can cause thrust linkages 602, 604, 802 to exert a pitch moment between the frame attachment points 812, 814 and the third frame attachment point 816 (e.g., the thermal expansion of the thrust linkage 602, 604 pushes the bottom of the second frame portion 204 along the roll axis and pivots the second frame portion 204 about the third frame attachment point 816, etc.).

In some examples, to mitigate the bending distortions caused by the thermal expansion of the thrust linkages 602, 604, 802, the thrust linkages 602, 604, 802 can be composed of materials with different coefficients of thermal expansion. For example, the first thrust linkage 602 and the second thrust linkage 604 can be composed of a first material with a lower coefficient of thermal expansion than a second material of the third thrust linkage 802. For example, the thrust linkages 602, 604 can be composed of nickel alloy 909 (e.g., INCONEL® 909, etc.) and the third thrust linkage 802 can be composed of nickel alloy 718 (e.g., INCONEL® 718, etc.) because the coefficient of thermal expansion of the nickel alloy 718 is ˜40% greater than the coefficient of thermal expansion of nickel alloy 909. In other examples, the thrust linkages 602, 604, 802 can be composed of any other materials that have different coefficients. Additionally or alternatively, the lengths 1004, 1006, and/or material of the thrust linkages 602, 604, 802 can be chosen such Equation (2) is true:

$${α}_{1} {L}_{1} Δ {T}_{1} \approx {α}_{2} {L}_{2} Δ {T}_{2} \qquad ( 2 )$$

where α₁ is the linear coefficient of thermal expansion for the material of the thrust linkages 602, 604, α₂ is the linear coefficient of thermal expansion for the material of the thrust linkages 802, L₁ is the original length of the thrust linkages 602, 604 (e.g., the room temperature lengths of the thrust linkages 602, 604, etc.), L₂ is the original length of the thrust linkage 802 (e.g., the room temperature lengths of the third thrust linkage 802, etc.), ΔT₁ is the change in temperature experienced by the thrust linkages 602, 604, and ΔT₂ is the change in temperature experienced by the third thrust linkage 802. Equation (2) includes the symbol “˜.” As used herein, the symbol indicates that the two quantities related by the symbol are approximately equal. In some examples, the materials and lengths of the thrust linkages of the third thrust linkage configuration 900 of FIG. 9 (e.g., the thrust linkages 602, 604, 902 of FIG. 9, etc.) can be similarly configured based on Equation (2).

The first forward mount 1001 is similar to the first forward mount 210 of FIG. 2, except that the first forward mount 1001 includes an elastomer bearing 1008. The elastomer bearing 1008 is disposed in the load path through the first forward mount 1001 between the gas turbine engine 1002 and the pylon 208. In the illustrated example of FIG. 10, the elastomer bearing 1008 is an elastomer bushing disposed around a pin of the first forward mount 1001. In other examples, the elastomer bearing 1008 is disposed at another suitable location in the load path through the first forward mount 1001. The comparatively lower stiffness of the elastomer bearing 1008 releases stress associated with the thermal expansion of the gas turbine engine 1002 during operation and the static indeterminateness of the engine mount system 1000. That is, the bending moments transmitted through the gas turbine engine 1002 are released (e.g., partially released, fully released, etc.) via the deformation of the elastomer bearing 1008 associated with a small displacement of the gas turbine engine 1002 relative to the pylon 208. In some examples, the elastomer bearing 1008 includes one or more of a natural rubber, a silicon rubber, a thermoplastic elastomer, a synthetic rubber, etc. In other examples, the first forward mount 1001 is implemented by the first forward mount 210 of FIG. 2, and the elastomer bearing 1008 is absent.

FIG. 11 is a perspective view of another example engine mount system 1100 including the second thrust linkage configuration 800 of FIG. 8, the first forward mount 1001 of FIG. 10, and the second forward mount 212 of FIG. 2. The engine mount system 1100 is similar to the engine mount system 1000 of FIG. 10, except that the engine mount system 1100 includes another example aft mount 1102 instead of the aft mount 500 of FIGS. 5A, 5B, and 10. In the illustrated example of FIG. 11, the engine mount system 1100 couples the gas turbine engine 1002 of FIG. 10 to the pylon 208 of FIGS. 2 and 10. In the illustrated example of FIG. 11, the engine mount system 1100 includes the second thrust linkage configuration 800 of FIG. 8.

Like the engine mount system 1000 of FIG. 10, the engine mount system 1100 is overconstrained (e.g., statically indeterminate, etc.). Accordingly, the components of the engine mount system 1100 and the gas turbine engine 1002 are sensitive to the thermal stress on the engine mount system 1100 (e.g., the thermal expansion of the components of the engine mount system 1100 can introduce internal stresses into the gas turbine engine 1002 and the engine mount system 1100, etc.). In some examples, the thrust linkages 602, 604, 802 can be designed based on Equation (2). That is, the lengths and materials of the thrust linkages 602, 604, 802 can be selected to mitigate (e.g., prevent, reduce, etc.) internal distortions caused by the thermal expansion of the engine mount system 1100 and the gas turbine engine 1002.

The aft mount 1102 is another aft mount implemented in accordance with the teachings of this disclosure and can be used to implement the aft mount 214 of FIG. 2. In the illustrated example of FIG. 11, the aft mount 1102 includes a leaf spring 1104, a mount member 1106, and a pylon coupling 1108. The leaf spring 1104 is an elastic element that resists tension applied between the pylon coupling 1108 and the third frame portion 206. In the illustrated example of FIG. 11, the leaf spring 1104 is disposed in the load path between the pylon 208 and the third frame portion 206, such that the leaf spring 1104 reacts negative vertical loads (e.g., gravitational loads, aerodynamic loads, maneuver loads, etc.) transferred between the pylon 208 and the third frame portion 206. In some examples, the leaf spring 1104 also reacts positive vertical loads (e.g., aerodynamic loads, maneuver loads, etc.). In some examples, the geometry and/or material of the leaf spring 1104 can be selected to reduce the distortion associated with gravitational and maneuver loading and to reduce the distortion associated with bending moments transferred between the aft mount 1102 and the forward mounts 212, 1001. For example, the thickness of the leaf spring 1104, the thickness profile of the leaf spring 1104, and/or the length of the leaf spring 1104 can be used to modify the stiffness of the aft mount 1102 and the distortion associated with the reaction of bending moments associated with the gas turbine engine 1002 via the engine mount system 1100.

The leaf spring 1104 can be composed of any suitable rigid material that is resistant to plastic deformation (e.g., a nickel alloy, steel, titanium, etc.). In some examples, to reduce internal stresses on the gas turbine engine 1002 caused by the thermal expansion of the leaf spring 1104, the leaf spring 1104 and/or the mount member 1106 can be composed of a material with a comparatively low coefficient of thermal expansion (e.g., nickel alloy 909, etc.). In the illustrated example of FIG. 11, the leaf spring 1104 includes a single leaf (e.g., a single bar of material, etc.). In other examples, the leaf spring 1104 can include multiple leaves (e.g., two leaves, three leaves, five leaves, etc.), which can modify the stiffness of the aft mount 1102 (e.g., cause the spring response of the leaf spring 1104 to be non-linear, etc.).

The pylon coupling 1108 couples the aft mount 1102 to the pylon 208. In some examples, the pylon coupling 1108 can be implemented by a pin linkage and/or a clevis (e.g., similar to the pylon coupling 302 of FIG. 3, similar to the pylon coupling 402 of FIG. 4, etc.). In other examples, the pylon coupling 1108 can be implemented by a boomerang linkage, a whiffletree linkage, a ball joint, a cotter joint, etc. Example couplings that can be used to couple the aft mount 1102 to the third frame portion 206 are described below in conjunction with FIGS. 12A-12G.

In the illustrated example of FIG. 11, the mount member 1106 is a rigid structural member that extends between the pylon coupling 1108 and the third frame portion 206 and reacts vertical loads transferred therebetween. In the illustrated example of FIG. 11, the mount member 1106 is a bar-shaped member. In other examples, the mount member 1106 can be implemented by a cylindrical member, a prismatic member, a tube, etc. The mount member 1106 can be composed of any suitable rigid material, including a same material as the leaf spring 1104, steel, titanium, aluminum, a nickel alloy, etc.

FIGS. 12A is a front view of the aft mount 1102 of FIG. 11 including an example first frame coupling 1200. In the illustrated example of FIG. 12A, the leaf spring 1104 includes a first eye 1201A and a second eye 1201B. In the illustrated example of FIG. 12A, the first frame coupling 1200 includes a first pin linkage 1202 and a first swing linkage 1204A. In the illustrated example of FIG. 12A, the first pin linkage 1202 includes a first pin 1206 and a first mounting boss 1208. In the illustrated example of FIG. 12B, the first swing linkage 1204A includes a second pin 1210, a third pin 1212, a second mounting boss 1214, and a linkage member 1216.

In the illustrated example of FIG. 12A, the mounting bosses 1208, 1214 are plates (e.g., a sheet member, etc.) that are fixedly coupled to and extend from the third frame portion 206. In other examples, one or both of the mounting bosses 1208, 1214 can be integral with the third frame portion 206. The first pin linkage 1202 is formed via the coupling of the first pin 1206 through the first eye 1201A of the leaf spring 1104 and the first mounting boss 1208. The first pin linkage 1202 reacts forces in the yaw and pitch directions. In the illustrated example of FIG. 12A, the first swing linkage 1204A is formed via (1) the coupling of the second pin 1210 through the second eye 1201B of the leaf spring 1104 and the linkage member 1216 and (2) the coupling of the third pin 1212 through the linkage member 1216 and the second mounting boss 1214. The first swing linkage 1204A reacts forces in the negative yaw direction. Accordingly, the combined use of the first swing linkage 1204A and the first pin linkage 1202 causes the first frame coupling 1200 to only react forces in the negative yaw direction. The first frame coupling 1200 facilitates the thermal expansion of the leaf spring 1104, the mount member 1106, and/or the third frame portion 206 by releasing pitch and positive yaw reactions via the first swing linkage 1204A and enabling small relative displacements between the aft mount 1102 and the third frame portion 206 in the pitch and positive yaw directions.

FIG. 12B is a front view of the aft mount 1102 of FIG. 11 including an example second frame coupling 1218. The second frame coupling 1218 includes the first swing linkage 1204A and is similar to the first frame coupling 1200, except that the second frame coupling 1218 includes a second swing linkage 1204B instead of the first pin linkage 1202. In the illustrated example of FIG. 12A, the second swing linkage 1204B is formed via (1) the coupling of a fourth pin 1220 through the first eye 1201A of the leaf spring 1104 and a second linkage member 1222 and (2) the coupling of a fifth pin 1224 through the second linkage member 1222 and the second mounting boss 1214. Like the first swing linkage 1204A, the second swing linkage 1204B reacts loads in the negative yaw. Accordingly, the second frame coupling 1218 facilitates the thermal expansion of the leaf spring 1104, the mount member 1106, and/or the third frame portion 206 by releasing pitch and positive yaw reactions via the first and second swing linkages 1204A, 1204B and enabling small relative displacements between the aft mount 1102 and the third frame portion 206 in the pitch and positive yaw directions.

FIG. 12C is a front view of the aft mount 1102 of FIG. 11 including a third frame coupling 1225. The third frame coupling 1225 includes the first pin linkage 1202 of FIG. 12A and is similar to the first frame coupling 1200 of FIG. 12A, except that the third frame coupling 1225 includes a first radial slot linkage 1226A instead of the first swing linkage 1204A of FIG. 12A. In the illustrated example of FIG. 12C, the first radial slot linkage 1226A is formed by the coupling of the second pin 1210 of FIG. 12A through the second eye 1201B and a first slot 1228 through the second mounting boss 1214 of FIG. 12A. In the illustrated example of FIG. 12C, the first slot 1228 has a radial orientation in the second mounting boss 1214. That is, the first slot 1228 has a major axis that is oriented along an axis that is perpendicular to the axial centerline of the third frame portion 206. The first slot 1228 enables the second pin 1210 to move within the first slot 1228 during the operation of the gas turbine engine 1002. The radial orientation of the first slot 1228 facilitates the movement of the second pin 1210 in the yaw direction and the radial direction. As such, the first radial slot linkage 1226A only reacts forces in the negative yaw. Accordingly, the combined use of the first radial slot linkage 1226A and the first pin linkage 1202 causes the third frame coupling 1225 to only react forces in the negative yaw direction. The third frame coupling 1225 facilitates the thermal expansion of the leaf spring 1104, the mount member 1106, and/or the third frame portion 206 by releasing pitch and positive yaw reactions via the first radial slot linkage 1226A and enabling small relative displacements between the aft mount 1102 and the third frame portion 206 in the pitch and positive yaw directions.

FIG. 12D is a front view of the aft mount of FIG. 11 including an example fourth frame coupling 1230. The fourth frame coupling 1230 includes the first radial slot linkage 1226A of FIG. 12D and is similar to the third frame coupling 1225 of FIG. 12C, except that the fourth frame coupling 1230 includes a second radial slot linkage 1226B instead of the first pin linkage 1202. In the illustrated example of FIG. 12D, the second radial slot linkage 1226B is formed via (1) the coupling of a first pin 1206 through the first eye 1201A of the leaf spring 1104 and a second slot 1232 in the first mounting boss 1208. Like the first radial slot linkage 1226A, the second radial slot linkage 1226B reacts forces in the negative yaw direction. Accordingly, the fourth frame coupling 1230 facilitates the thermal expansion of the leaf spring 1104, the mount member 1106, and/or the third frame portion 206 by releasing pitch and positive yaw reactions via the radial slot linkages 1226A, 1226B and enabling small relative displacements between the aft mount 1102 and the third frame portion 206 in the pitch and positive yaw directions.

FIG. 12E is a front view of the aft mount of FIG. 11 including an example fifth frame coupling 1234. The fifth frame coupling 1234 includes the first pin linkage 1202 of

FIG. 12A and is similar to the first frame coupling 1200 of FIG. 12A, except that the fifth frame coupling 1234 includes a first lateral slot linkage 1236A instead of the first swing linkage 1204A of FIG. 12A. In the illustrated example of FIG. 12E, the first lateral slot linkage 1236A is formed by the coupling of the second pin 1210 of FIG. 12A through the second eye 1201B and a second lateral slot 1240 through the second mounting boss 1214 of FIG. 12A. That is, the second lateral slot 1240 has a major axis that is oriented along the pitch axis. The second lateral slot 1240 enables the second pin 1210 to move within the second lateral slot 1240 during the operation of the gas turbine engine 1002. The lateral orientation of the second lateral slot 1240 facilitates the movement of the second pin 1210 in the pitch direction. As such, the first lateral slot linkage 1236A only reacts forces in the negative yaw direction. Accordingly, the combined use of the first lateral slot linkage 1236A and the first pin linkage 1202 causes the fifth frame coupling 1234 to only react forces in the negative yaw direction. The fifth frame coupling 1234 facilitates the thermal expansion of the leaf spring 1104, the mount member 1106, and/or the third frame portion 206 by releasing pitch and positive yaw reactions via the first lateral slot linkage 1236A by enabling small relative displacements between the aft mount 1102 and the third frame portion 206 in the pitch and positive yaw directions.

FIG. 12F is a front view of the aft mount of FIG. 11 including an example sixth frame coupling 1238. The sixth frame coupling 1238 includes the first lateral slot linkage 1236A and is similar to the fifth frame coupling 1234 of FIG. 12E, except that the sixth frame coupling 1238 includes a second lateral slot linkage 1236B instead of the first pin linkage 1202. In the illustrated example of FIG. 12F, the second lateral slot linkage 1236B is formed via the coupling of a first pin 1206 through the first eye 1201A of the leaf spring 1104 and a second lateral slot 1240 in the first mounting boss 1208. Like the first lateral slot linkage 1236A, the second lateral slot linkage 1236B reacts loads in the negative yaw. Accordingly, the sixth frame coupling 1238 facilitates the thermal expansion of the leaf spring 1104, the mount member 1106, and/or the third frame portion 206 by releasing pitch and positive yaw reactions via the lateral slot linkages 1236A, 1236B by enabling small relative displacements between the aft mount 1102 and the third frame portion 206 in the pitch and positive yaw directions.

FIG. 12G is a front view of the aft mount of FIG. 11 including an example seventh frame coupling 1241. The seventh frame coupling 1241 includes the first pin linkage 1202 of FIG. 12A and an example second pin linkage 1242. The example second pin linkage 1242 is similar to the first pin linkage 1202 of FIG. 12A. In the illustrated example of FIG. 12A, the second pin linkage 1242 is formed via the coupling of the second pin 1210 through the second eye 1201B of the leaf spring 1104 and the second mounting boss 1214. The seventh frame coupling 1241 reacts loads in the positive and negative yaw directions and the pitch direction.

From the foregoing, it will be appreciated that example systems, apparatus, articles of manufacture, and methods have been disclosed to reduce engine carcass distortions associated with operational distortions caused by bending moments associated with the thrust, aerodynamic, and/or propeller loads and reduce distortions caused by the gravitational loading associated with cantilevered core engines. Example mount systems disclosed herein aft mounts with an elastic member, which offers comparatively reduced stiffness of the coupling between the rear frame and the pylon. Examples disclosed herein facilitate tighter blade tip clearances, particularly in cantilevered open-rotor gas turbine engines, which can provide increased engine performance and reduced fuel consumption. Examples disclosed herein include mounting configurations with multiple thrust linkages that are laterally and vertically displaced, which enables the reaction of yaw and/or pitch moment via the thrust linkages.

Methods and apparatus for mounting a gas turbine engine to a pylon are disclosed herein. Further examples and combinations thereof include the following:

A gas turbine engine, comprising a first mount, a first frame portion to be coupled to a pylon via the first mount, a second frame portion coupled to the first frame portion such that the second frame portion is cantilevered from the first frame portion, and a second mount to couple the second frame portion to the pylon, the second mount defining a load path between the pylon and the second frame portion, the second mount including an elastic element disposed in the load path.

The gas turbine engine of any preceding clause, wherein the elastic element is an elastomer.

The gas turbine engine of any preceding clause, wherein the second mount includes a frame coupling, a pylon coupling including a bracket coupled to the pylon, and a load plate movably disposed within the bracket, wherein the elastomer is disposed between the load plate and the bracket, and a structural member extending between the frame coupling and the pylon coupling, the structural member coupled to the load plate.

The gas turbine engine of any preceding clause, wherein the elastomer is a first elastomer and further including a second elastomer disposed between the load plate and the pylon.

The gas turbine engine of any preceding clause, wherein the elastic element is a leaf spring.

The gas turbine engine of any preceding clause, wherein the elastic element is a disc spring.

The gas turbine engine of any preceding clause, wherein the second mount includes a first member coupled to the pylon, a second member coupled to the second frame portion, a flange coupled to the first member, and a pin extending through the first member and the second member, the disc spring being disposed between the flange and the pin.

The gas turbine engine of any preceding clause, wherein the disc spring is a first disc spring and the second mount further includes a mounting plate coupled to the pylon and the second member, and a second disc spring disposed between the flange and the mounting plate.

The gas turbine engine of any preceding clause, wherein the first member has a hollow interior, the second member is disposed within the hollow interior such that a gap is formed between an outer diameter of the second member and an inner diameter of the first member, and the pin and the gap facilitate a rotation of the first member relative to the second member.

The gas turbine engine of any preceding clause, wherein the second mount includes a slot, the second frame portion coupled to the second mount via the slot, the slot facilitating a rotation about a yaw-axis relative to the pylon.

The gas turbine engine of any preceding clause, further including a first thrust linkage extending between a third frame portion and the pylon at a first block attachment point, a second thrust linkage extending between the third frame portion and the pylon at a second block attachment point laterally displaced from the first block attachment point, and a third thrust linkage extending between the third frame portion and a third block attachment point vertically displaced from the first block attachment point.

The gas turbine engine of any preceding clause, wherein the first thrust linkage has a first length and includes a first material, and the third thrust linkage has a second length and includes a second material, the first length greater than the second length, the first material having a lower coefficient of thermal expansion than the second material.

An apparatus comprising a first mount coupling a first frame portion of a gas turbine engine to a pylon, and a second mount coupling a second frame portion of the gas turbine engine to the pylon, the second mount including an elastic element, the second frame portion cantilevered relative to the first frame portion, the second mount defining a load path between the pylon and the second frame portion, wherein the elastic element is disposed in the load path.

The apparatus of any preceding clause, wherein the elastic element is an elastomer.

The apparatus of any preceding clause, wherein the second mount includes a frame coupling, a pylon coupling including a bracket coupled to the pylon, and a load plate movably disposed within the bracket, wherein the elastomer is disposed between the load plate and the bracket, and a structural member extending between the frame coupling and the pylon coupling, the structural member coupled to the load plate.

The apparatus of any preceding clause, wherein the elastic element is a spring.

The apparatus of any preceding clause, wherein the second mount further includes at least one of a slot linkage or a swing linkage coupling an eye of the spring to the second frame portion.

The apparatus of any preceding clause, wherein the second mount further includes a first member coupled to the pylon, a second member coupled to the second frame portion, a flange coupled to the first member, and a pin extending through the first member and the second member, the spring disposed between the flange and the pin.

The apparatus of any preceding clause, wherein the spring is a first spring and the second mount further includes a mounting plate coupled to the pylon and the second member, and a second spring disposed between the flange and the mounting plate.

The apparatus of any preceding clause, wherein the first member has a hollow interior, the second member is disposed within the hollow interior such that a gap is formed between an outer diameter of the second member and an inner diameter of the first member, and the pin and the gap facilitate a rotation of the first member relative to the second member.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A gas turbine engine, comprising:
a first mount;
a first frame portion to be coupled to a pylon via the first mount;
a second frame portion coupled to the first frame portion such that the second frame portion is cantilevered from the first frame portion; and
a second mount to couple the second frame portion to the pylon, the second mount defining a load path between the pylon and the second frame portion, the second mount including an elastic element disposed in the load path.

2. The gas turbine engine of claim 1, wherein the elastic element is an elastomer.

3. The gas turbine engine of claim 2, wherein the second mount includes:
a frame coupling;
a pylon coupling including:
a bracket coupled to the pylon; and
a load plate movably disposed within the bracket;
wherein the elastomer is disposed between the load plate and the bracket; and
a structural member extending between the frame coupling and the pylon coupling, the structural member coupled to the load plate.

4. The gas turbine engine of claim 3, wherein the elastomer is a first elastomer and further including a second elastomer disposed between the load plate and the pylon.

5. The gas turbine engine of claim 1, wherein the elastic element is a leaf spring.

6. The gas turbine engine of claim 1, wherein the elastic element is a disc spring.

7. The gas turbine engine of claim 6, wherein the second mount includes:
a first member coupled to the pylon;
a second member coupled to the second frame portion;
a flange coupled to the first member; and
a pin extending through the first member and the second member, the disc spring being disposed between the flange and the pin.

8. The gas turbine engine of claim 7, wherein the disc spring is a first disc spring and the second mount further includes:
a mounting plate coupled to the pylon and the second member; and
a second disc spring disposed between the flange and the mounting plate.

9. The gas turbine engine of claim 7, wherein the first member has a hollow interior, the second member is disposed within the hollow interior such that a gap is formed between an outer diameter of the second member and an inner diameter of the first member, and the pin and the gap facilitate a rotation of the first member relative to the second member.

10. The gas turbine engine of claim 1, wherein the second mount includes a slot, the second frame portion coupled to the second mount via the slot, the slot facilitating a rotation about a yaw-axis relative to the pylon.

11. The gas turbine engine of claim 1, further including:
a first thrust linkage extending between a third frame portion and the pylon at a first block attachment point;
a second thrust linkage extending between the third frame portion and the pylon at a second block attachment point laterally displaced from the first block attachment point; and
a third thrust linkage extending between the third frame portion and a third block attachment point vertically displaced from the first block attachment point.

12. The gas turbine engine of claim 11, wherein:
the first thrust linkage has a first length and includes a first material; and
the third thrust linkage has a second length and includes a second material, the first length greater than the second length, the first material having a lower coefficient of thermal expansion than the second material.

13. An apparatus, comprising:
a first mount coupling a first frame portion of a gas turbine engine to a pylon; and
a second mount coupling a second frame portion of the gas turbine engine to the pylon, the second mount including an elastic element, the second frame portion cantilevered relative to the first frame portion, the second mount defining a load path between the pylon and the second frame portion, wherein the elastic element is disposed in the load path.

14. The apparatus of claim 13, wherein the elastic element is an elastomer.

15. The apparatus of claim 14, wherein the second mount includes:
a frame coupling;
a pylon coupling including:
a bracket coupled to the pylon; and
a load plate movably disposed within the bracket; wherein the elastomer is disposed between the load plate and the bracket; and
a structural member extending between the frame coupling and the pylon coupling, the structural member coupled to the load plate.

16. The apparatus of claim 13, wherein the elastic element is a spring.

17. The apparatus of claim 16, wherein the second mount further includes at least one of a slot linkage or a swing linkage coupling an eye of the spring to the second frame portion.

18. The apparatus of claim 16, wherein the second mount further includes:
a first member coupled to the pylon;
a second member coupled to the second frame portion;
a flange coupled to the first member; and
a pin extending through the first member and the second member, the spring disposed between the flange and the pin.

19. The apparatus of claim 18, wherein the spring is a first spring and the second mount further includes:
a mounting plate coupled to the pylon and the second member; and
a second spring disposed between the flange and the mounting plate.

20. The apparatus of claim 19, wherein the first member has a hollow interior, the second member is disposed within the hollow interior such that a gap is formed between an outer diameter of the second member and an inner diameter of the first member, and the pin and the gap facilitate a rotation of the first member relative to the second member.
